(19) United States
(12) Patent Application Publication
(10) Pub. No.: US 2009/0132367 A1
(43) Pub. Date: May 21, 2009

(54) ELECTRONIC ADVERTISEMENT SYSTEM

(76) Inventors: Takuji HAMADA, Hitachiohta (JP); Hiroshi Kurihara, Kawasaki (JP); Kazuho Miki, Musashino (JP); Shigeki Kitajima, Kawasaki (JP)

Correspondence Address: MATTINGLY & MALUR, P.C., 1800 DIAGONAL ROAD, SUITE 370, ALEXANDRIA, VA, 22314, US

(21) Appl. No.: 12/211,972

(22) Filed: Sep. 17, 2008

(30) Foreign Application Priority Data
Nov. 21, 2007 (JP) 2007-301698

(51) Int. Cl. G06Q 30/00

(52) U.S. Cl. 705/14

(57) ABSTRACT

There is disclosed an electronic advertisement system including: an advertisement displaying device; a local area network that transmits a summary of a content to a terminal; a wide area network that has at least one local area network and gains access to a detail of the content corresponding to receiving the summary by the terminal; and a center device that stores the details of the content, monitors the access to the stored detail of the content, and changes the schedule of an advertisement displayed on the advertisement displaying device located near the local area network based on the monitored result.

### BACKGROUND OF THE INVENTION

1. Field of the Invention

The present invention is directed to a digital signage for displaying advertisement contents in shops or public places, and more particularly to a method suitable for displaying ordered advertisement content in places and times that passerby are greatly interested.

2. Description of the Related Art

It is a key issue to know where, when and what contents should be displayed to gain the maximum effects in an electronic advertisement system using networks. As a method, JP-A-2005-267611 discloses a method of capturing and analyzing the face of passerby watching an advertisement monitor by a camera, thereby selecting and displaying content considered to be statistically most effective for the viewer. JP-A-1999-153977 discloses a method of collecting reaction information of passerby facing camera images or voices before advertising and sending the collected reaction information to a monitor center to analyze the advertising effects.

### SUMMARY OF THE INVENTION

As disclosed in the above documents, the method of capturing/monitoring passerby watching an electronic advertisement by the camera, so as to evaluate passerby's degree of interest on the advertisement content from the reaction/activity of the passerby, may have difficulty in capturing an image for each and every passerby, in particular, in places, such as cities, where crowds may include an enormous number of passerby or where advertisements are placed not only in wide open spaces but also narrow streets. In addition, this method is difficult to make an exact determination between individual difference in reaction to advertisement and passerby's negative response against being taken shot by a camera. It requires high cost to use bread band network which can transmit capture images and high performance image processing devices which can eliminate human checking of passerby reaction.

Therefore, there is a need of being capable of evaluating a user's degree of interest on electronic advertisement content correctly and with lowered price.

According to an exemplary embodiment of the present invention, there is provided an electronic advertisement system including: advertisement displaying devices that displays an advertisement based on a schedule displaying the advertisement; at least one local area network or a short range and dedicated wireless network that transmits or broadcasts a summary of a content to terminals near the display; a wide area network like a cellular network that has a first communication area including a second communication area that is formed by the local area network, wherein the wide area network is used to access to the detail content in a center facilities by the terminal based on the collected summary information; and a center facilities connected to the advertisement displaying devices, and the wide area network, wherein the center facilities store the detail of the content, monitor the access to the stored detail of the content, and change the display schedule on the advertisement displaying devices located in the first communication area based on the monitored result.

According to the exemplary embodiment of the present invention, it may be possible to determine whether or not there are those interesting in an advertisement content among users approaching an electronic advertisement, such that a requested advertisement can be displayed more properly in places and times where the users are greatly interested.

### BRIEF DESCRIPTION OF THE DRAWINGS

FIG. 1 is a diagram illustrating a first embodiment of the present invention;

FIG. 2 is a diagram illustrating an entire construction of the first embodiment;

FIG. 3 is a diagram schematically illustrating a series of operations according to the first embodiment;

FIG. 4 is a diagram illustrating main components of the first embodiment;

FIGS. 5A to 5C are diagrams illustrating an exemplary information table relating to transmission of summary content or advertisement content;

FIGS. 6A to 6C are diagrams illustrating an exemplary information table relating to summary content or advertisement content;

FIG. 7 is a diagram illustrating an exemplary information table relating to a schedule;

FIG. 8 is a diagram illustrating an exemplary collection (counted information) table;

FIG. 9 is a diagram illustrating an operation process of a terminal according to the first embodiment;

FIG. 10 is a diagram illustrating an operation process of initial preparation and a receive of summary content in a terminal according to the first embodiment;

FIG. 11 is a diagram illustrating an operation process of a detailed content access in a terminal according to the first embodiment;

FIG. 12 is a diagram illustrating an example of a system construction according to a second embodiment;

FIG. 13 is a diagram illustrating a user table according to the second embodiment;

FIG. 14 is a diagram illustrating an operation process of a terminal according to the second embodiment; and

FIG. 15 is a diagram illustrating an access flow of a terminal according to the second embodiment.

### DETAILED DESCRIPTION OF THE PREFERRED EMBODIMENTS

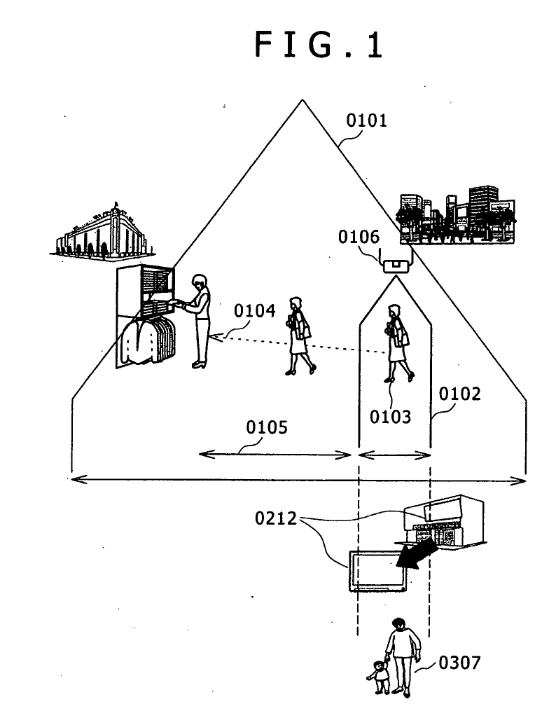

Hereinafter, exemplary embodiments of the present invention will be described with reference to the accompanying drawings. FIG. 1, which simulates one use scene of user, illustrates a relationship between a known wide area first network 0101, for example such as a cellular network, and a wireless local area second network 0102 that may exist within plural a first network, for example such as a WiFi (Wireless Fidelity) network. The reference numeral ‘0106’ refers to a WiFi wireless access point. A terminal should be able to correspond to the access point 0106 to access the second network.

As shown in FIG. 1, with respect to an area to which a user or the user's terminal 0103 may gain access, the second network is narrower than the first network. When moving in the direction indicated by a dashed arrow 0104, a user (or his/her terminal) 0103 may not access the second network in an area 0102 during moving an area 0105.

In such a use scene, the user gains access to the second network with his terminal in the area 0102 to receive and store summary content about the genre that was preset in the terminal by the user, and views (checks) the stored summary content in the area 0102 during moving an area 0105. If the user has any interest in the summary content, the user may access the detailed content through the first network 0101 (in order to receive the detailed information on the summary content).

This must be convenient for the person who wants to buy one's favorite articles without much effort to find out. For example, in a situation where the shopper gets summary content or access key on women's clothes at the place corresponding to the area 0102 in a shopping area, and she checks the summary content (short and summarized information on the women's cloths) while she is walking along the street or eating at the restaurant in the area corresponding to the area 0105. If the person is interested in the article, the person easily gets the detail information on the clothes such as the guide map to the shop, the product information on color and size to access the center facility through the first network. And then she goes to the shop to buy it.

FIG. 1 shows an exemplary advertisement displaying device 0212 which displays an advertisement for a number of unspecified users 0307 who do not carry a terminal but are located near the area 0102. The displaying device 0212 may be a large size display attached to an external wall of a building, which can generally be seen on the street. In this exemplary embodiment, for example, a center system (center device) collects information indicating that the user 0103 carrying the terminal that has acquired summary content of a preset genre was attracted by the summary content to access the detailed content (hereinafter, referred to as “access information”), and displays advertisement content interested by the user and other advertisement contents of the same genre as the popular advertisement content on the display device 0212 based on the collected results. As the case may be, the advertisement content displayed on the display device 0212 may be changed into another one. By doing so, it is possible to provide advertisement content considered to be useful for unspecified users 0307 that not carry the terminal.

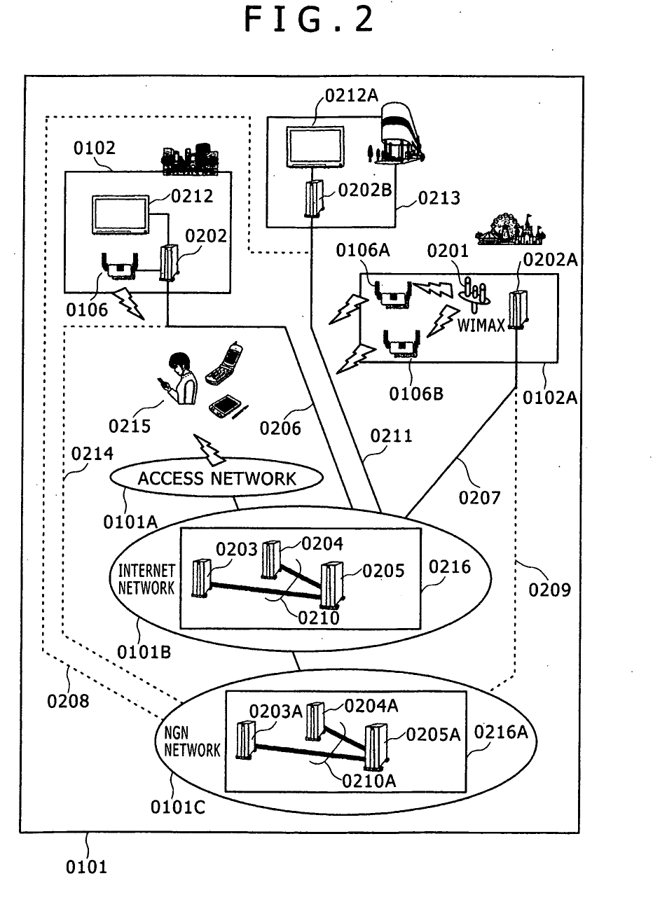

FIG. 2 is a view illustrating an example of an entire process according to an exemplary embodiment of the present invention. Referring to FIG. 2, two second networks 0102 and 0102A are contained in the first network 0101 which covers a wide area. As such, the local area of the second network can be various networks, such as a WiFi wireless, and may be provided in the first network area, and the second network may be provided in plurality.

Reference numerals 0106, 0106A, and 0106B refer to access points in the second network. A case is exemplified in FIG. 2, where there are two WiFi access points 0106A and 0106B provided near an antenna 0201 of WiMAX (Worldwide Interoperability for Microwave Access) in the second network 0102A.

The second network 0102 is connected to a subscriber line 0206 and the Internet 0101B via an access point 0106. Similarly, the second network 0102A is connected to a subscriber line 0207 and the Internet 0101B via the access points 0106A and 0106B. It is also possible when the terminal 0215 has direct access to the antenna 0201, then the terminal 0215 has a means to directly access the WiMAX antenna 0201. In this case, the access point 0106 may also function as another WiMAX antenna.

The terminal 0215 shown in FIG. 2 includes a communication means that may access the first network covering a wide area, and a communication means that may access any one of the existing plurality of second networks that covers only a local area.

The access to the first network may be actually performed by the terminal accessing an access network 0101A in which plural access networks exist in the first network area 0101. The terminal 0215 may gain access to an NGN (Next Generation Network) 0101C or Internet network 0101B via the access network 0101A. An example is illustrated in FIG. 2, where the terminal 0215 accesses the NGN 0101C via the Internet 0101B. The network configuration may also be possible, when the terminal 0215 has direct access from the access network 0101A to the NGN 0101C, and therefore, it should be noted that the relationship among the networks 0101A, 0101B, and 0101C does not have an essential meaning in this exemplary embodiment.

That is, the server system group denoted by reference numeral 0216 may be existent in the Internet network 0101B or the NGN 0101C. It is not essential in the exemplary embodiment where the server system group is located. FIG. 2 shows a case where the server system 0216 exists in the Internet network 0101B and the server system 0216A exists in the NGN. Of course, the server system 0216 may exist in the NGN and the server system 0216A may exist in the Internet network 0101B.

As such, the first network may represent the area 0101 as seen from the terminal 0215, the access network 0101A located nearest the terminal, the network including the Internet 0101B and NGN 0101C, or the network including the overall networks 0101A, 0101B, and 0101C. Hereinafter, if otherwise described, it is assumed that the first network is located in the sub system 0216 over the Internet 0101B.

An example of the terminal 0215 shown in FIG. 2 may include a cellular phone, and a PDA (Portable Digital Assistant). If the terminal 0215 is a cellular phone embedded with a wireless LAN module, then the access network 0101A shown in FIG. 2 may correspond to a public network for cellular phones. And, in FIG. 2, reference numerals 0212 and 0212A denote advertisement displaying devices; reference numerals 0202, 0202B, and 0202A denote summary transmitting server systems; reference numerals 0203, 0203A, 0204, and 0204A denote detailed content transmitting server systems; and reference numerals 0205 and 0205A denote management control server systems.

The difference between the two detailed content transmitting server systems 0203 and 0203A is whether each is connected through the Internet network or NGN. This is also true for the difference between the detailed content transmitting server systems 0204 and 0204A, or between the management control server systems 0205 and 0205A. FIG. 2 illustrates the management control server system and the detailed content transmitting server system are located in the same networks as the networks 0210 and 0210A and connected to each other, but the present invention is not limited thereto. For example, the detailed content transmitting server system 0202 connected to the management control server system 0205 may be existent over the NGN.

Generally, plural detailed content transmitting server systems may be commonly provided as in FIG. 2, which illustrates two detailed content transmitting server systems 0203 and 0204 connected to each other. It is more common to have plural detailed content transmitting server systems than a single detailed content transmitting server system. That is, each of the various web sites that may be seen over the Internet is generally located in each of the plural systems (servers).

In the meantime, the summary transmitting server system is located at a hub of the second network or at a local area that may access the communication environment of the second network. Plural access points or Plural advertisement displaying devices are connected to a single summary transmitting server system.

Even though a case is exemplified in FIG. 2, where one access point 0106 and one advertising display device 0212 are connected to the summary transmitting server system 0202, the present invention is not limited thereto.

For example, two advertisement displaying devices may be connected to the summary transmitting server system 0202, both of which display the same advertisement content or one of which displays the different advertisement content from that of the other at the same time.

In a case where an advertisement displaying device is connected to the summary transmitting server system 0202, the summary transmitting server system 0202 is configured to control the advertisement content. For example, in a case where two advertisement displaying devices are connected to the summary transmitting server system 0202, advertisement content to be displayed on the advertisement displaying devices, whether it is displayed on only one or both of the two advertisement displaying devices, is managed and controlled by the summary transmitting server system 0202 connected to the two advertisement displaying devices.

In addition, no access points are connected to the summary transmitting server system. In area 0213 of FIG. 2, an advertisement displaying device may only be connected to the summary transmitting server system. Therefore, the summary transmitting server system can be installed at any restrictive place (local area), for example such as a street, according to the connection with the access point or advertisement displaying device, and transmit summary content via the access point to the terminal 0215 or displays advertisement content on the advertisement displaying device. The summary transmitting server system also provides or transmits/displays advertisement content to unspecified users 0307 who do not carry their own terminal as shown in FIG. 1.

The configuration of devices to be connected to the summary transmitting server system is managed by a management control server system 0205 to be described below, which corresponds to the center system. An advertisement content to be displayed on the advertisement displaying device is scheduled by the management control server system. Further, the management control server system instructs the summary transmitting server system to display what advertisement content on which advertisement displaying device, and the summary transmitting server system displays the advertisement on the advertisement displaying device connected to the summary transmitting server system in accordance to the instruction a schedule.

The summary transmitting server systems 0202, 0202B, and 0202A are communicatively connected to the management control server system that is located over the Internet network 0101B via the subscriber lines 0206, 0211, and 0207, respectively. As described above, in a case where the management control server system is located not over the Internet network 0101B but over the NGN 0101C, the subscriber lines 0206, 0211, and 0207 for the summary transmitting server system 0202, 0202B, and 0202A are replaced with other subscriber lines 0214, 0208, and 0209, respectively, which are respectively connected to the management control server system 0205A. Even in this case, it is possible for each summary transmitting server system to be communicatively connected via each of the subscriber lines 0206, 0211, and 0207 and the Internet 0101B to the management control server system 0205A located over the NGN. Although, connecting the summary transmitting server system to the management control server system may be implemented in various ways, and accordingly, it should be noted that these aspects are not essential for the present invention.

As described above, the exemplary embodiment of the present invention includes the first network covering a wide area, the second network provided in plurality in the first network and covering a narrow local area, and the advertising display device provided in plurality in the first network and installed in the local area, wherein the access point or the advertisement displaying device located in the second network is connected to the summary transmitting server system and the summary transmitting server system is connected to the management control server system. In this exemplary embodiment, only the advertisement displaying device may be connected to the summary transmitting server system as in the area 0213, or only the access point may be connected to the summary transmitting server system as in the area 0102A.

In this exemplary embodiment, the user 0103 who carries his own terminal shown in FIG. 1 may also obtain summary content concerning a genre preset by the user through an access of the terminal 0215 (user terminal 0103 shown in FIG. 1) to the second network (for example, the terminal may obtain the summary content from the summary transmitting server system 0202 through the access point 0106). The user 0103, who has obtained the summary content, is attracted by the summary content to access the first network to actually gain access to the detailed content (for example, the user accesses a detailed content transmitting server system 0203 through the access network 0101A). The management control server system collects information on the fact that the terminal has accessed the detailed content (access information), and performs scheduling on each of the advertisement displaying devices connected to the summary transmitting server system based on the collected results, so that the content with high popularity and other advertisement contents of the same genre as the popular content may be displayed on the advertisement displaying devices (or the advertisement content currently displayed on the advertisement displaying devices may be changed to another one). The management control server system indicates the displaying schedule to the summary transmitting server system connected to the corresponding advertisement displaying devices. The summary transmitting server system displays (or changes) the advertisement content according to the indication. By doing so, the advertisement content may be provided to the unspecified users 0307, shown in FIG. 1, who are located near the advertisement displaying device.

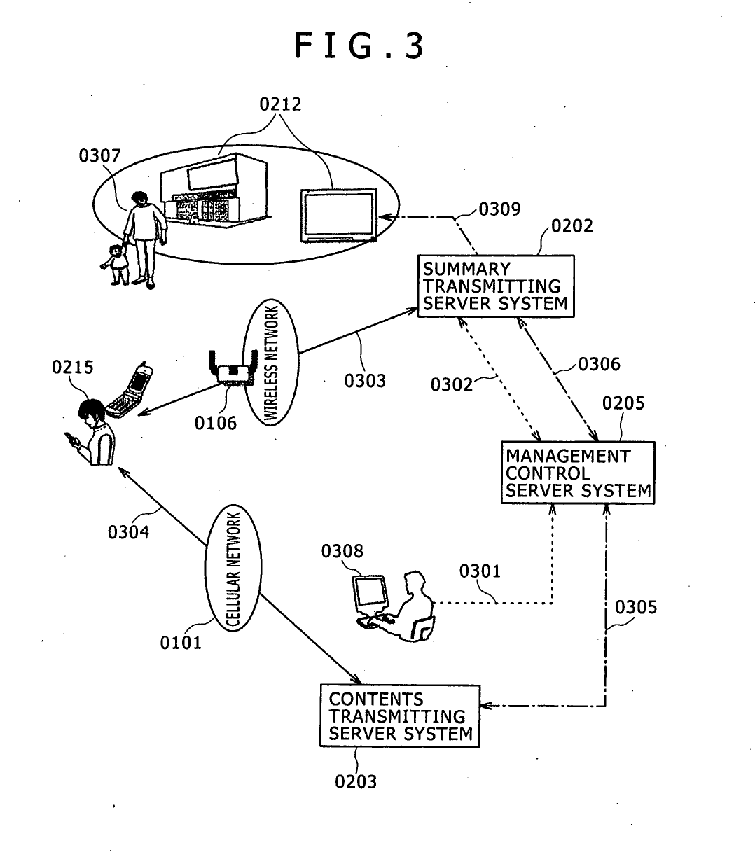

FIG. 3 is a diagram illustrating an example of a relationship among the user carrying the terminal, the terminal, the summary transmitting server system, the detailed content transmitting server system, the management control server system, the advertisement displaying device, and the unspecified users.

In FIG. 3, the reference numeral “0308” corresponds to an advertisement provider, a (detailed) content provider, or a system operator. That is, the reference numeral 0308 refers to registering or generating content. The registered content may include summary contents concerning detailed content or advertisement content displayed on the advertisement displaying device. The registered content may also include additive information associated with the summary content or advertisement content. The additive information may be, for example, a URL (Uniform Resource Locator) of the detailed content. As the content, only a summary of the detailed content (however, the provision of the summary content and preparation of the detailed content are performed in a pair) or only the advertisement content displayed on the advertisement displaying device may be provided. However, it is not necessary that both of the contents should be provided together.

The content that the provider 0308 registers to the management control server system through a line 0301 is transmitted from the management control server system to the summary transmitting server system 0202 located in each local area through a line 0302. The line 0301 includes the subscriber lines 0206 and 0214 as shown in FIG. 2. When a system operator is denoted by reference numeral 0308, for example, the line 0301 may be an Intranet line in the management control server system.

The registered content (summary content, advertisement content) is transmitted to each and every summary transmitting server system to match desired conditions of the content provider according to the position of the summary transmitting server system and a configuration of connected devices (configuration of access points or advertisement displaying devices) that are separately managed by the management control server system.

For example, if a desired condition of the content provider is limited to a domestic transmission, the advertisement content is transmitted only to the summary transmitting server systems that are located within the country, and the advertisement content is not transmitted to the summary transmitting server systems to which no advertisement displaying devices are connected. At this time, the advertisement content is transmitted together with the displaying schedule to the summary transmitting server systems that are distributed in various locations around the management control server system.

The line 0302, through which the content is transmitted to the summary transmitting server systems, corresponds to the lines 0206, 0211, 0207, 0214, 0208, and 0209 shown in FIG. 2. Among the contents treated by the summary transmitting server system, the summary content is provided to the terminal (or user) 0215 and the advertisement content is displayed on the advertisement displaying device.

The user 0215 that carries his/her own terminal previously registers a desired genre of a content, for example, such as western food, women's clothing, etc. In an external location such as a shopping place, this user maintains a communication means of the terminal activated to be able to perform communication through the second network. If the user reaches a local area in the second network 0303, the user receives summary content for the western food or women's clothing from the summary transmitting server system. The user may check the summary content received while traveling or stationary, such as eating at a restaurant with his/her terminal, and if he knows what the detailed content is, the user gains access to the detailed content transmitting server system through the first network 0304 to identify the detailed content. For example, the summary content may contain URL information or address information of the detailed content provided through the first network. The storing process is performed by the management control server system, and the summary content already has the URL or address information of the detailed content before the summary content is transmitted to the summary transmitting server system. The user may gain access to the detailed content transmitting server system that provides the detailed content corresponding to the summary content through the first network merely by selecting the summary content that contains the desired content using the terminal 0215.

Upon access to the detailed content transmitting server system, the terminal 0215 provides information on the position or time zone of the received summary content to the detailed content transmitting server system 0203, and the detailed content transmitting server system 0203 manages the above information including information that the terminal has accessed the detailed content transmitting server system (i.e. access information). The detailed content transmitting server system manages the information when the terminal has received the summary content and has accessed the detailed content transmitting server system by. Further, the access information is periodically collected by the management control server system through the line 0305. The line 0305 corresponds to the lines 0210 and 0210A shown in FIG. 2.

The management control server system 0205 that periodically collects the access information from each of the plural detailed content transmitting server systems produces, for example, a popular content or a genre which the popular content belongs to, reschedules the displaying schedule of the advertisement content, and re-instructs the summary transmitting server systems (to which the advertisement displaying devices are connected) distributed in various positions to display a new advertisement content on the advertisement displaying device based on the collected access information (0306).

The reference numeral 0306 simulates the re-instruction, and is merely anointer expression of the reference numeral 0302. Reference numeral 0306 corresponds to lines 0206, 0211, 0207, 0214, 0208, and 0209, similar to the reference numeral 0302. That is, the reason why reference numerals 0302 and 0306 are expressed separately from each other is that line 0302 denotes when an original schedule from the management control server system 0205 is transmitting to the summary transmitting server system 0202 and line 0306 denotes when retransmitting due to the schedule (reschedule) being modified from the management control server system 0205 to the summary transmitting server system 0202.

The summary transmitting server system 0202 that has received the reschedule rejects the advertisement content (or displaying schedule) that has been displayed on the advertisement displaying device 0212 until the summary transmitting server system receives the updated schedule and displays the advertisement content according to the updated schedule (0309).

As such, in the exemplary embodiment, the management control server system 0205 collects the access information when the user carrying his own terminal has received summary content of an interested genre and has actually accessed the detailed content to receive the detailed content, and displays the advertisement content or changes the current advertisement content to another one based on the collected access information for the unspecified users 0307 that are located near the advertisement displaying device regardless of whether they carry their own terminal or not.

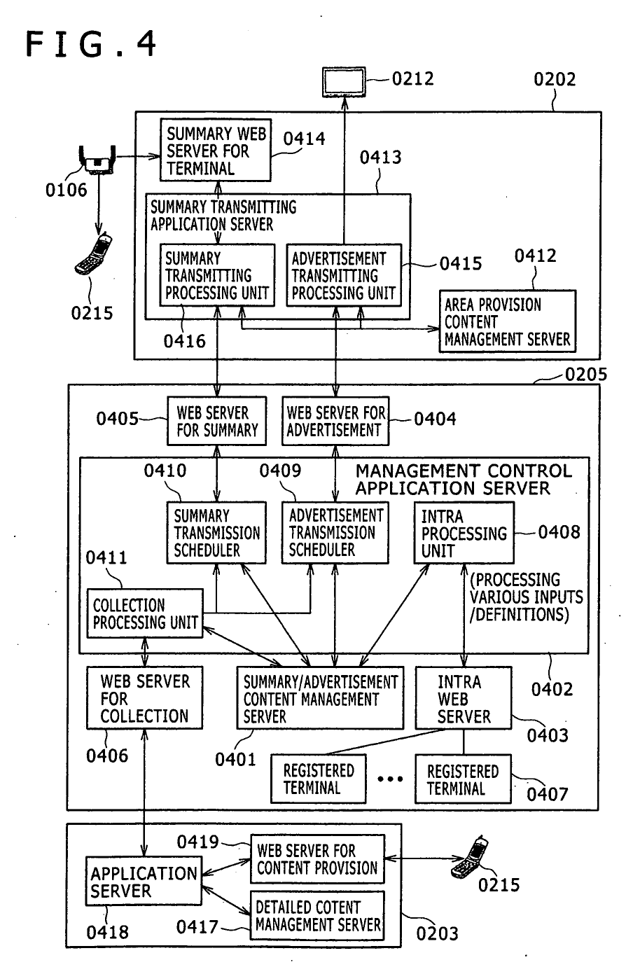

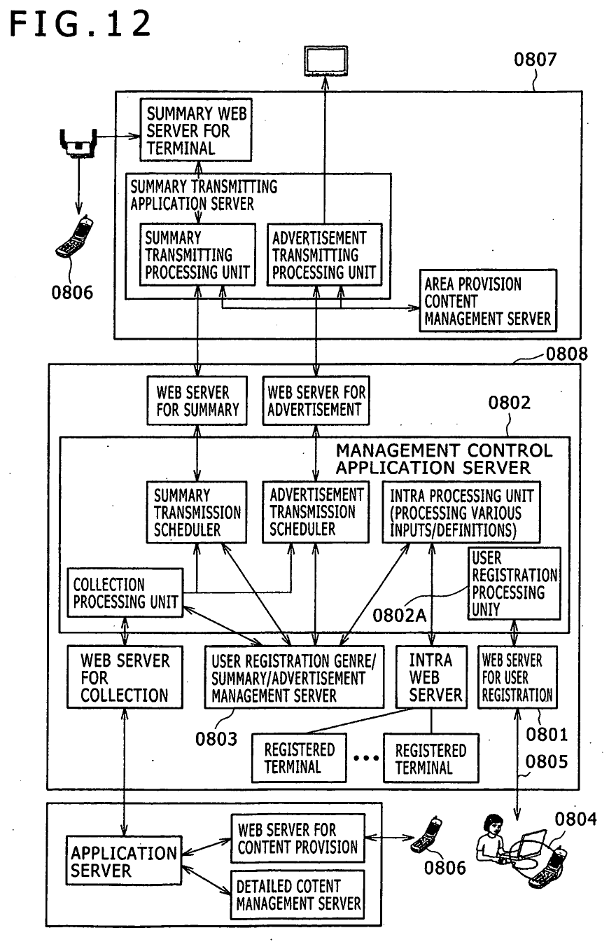

Hereinafter, a first embodiment will be described with reference to FIGS. 4, 5, 6, 7, 8, 9, 10, and 11, and a second embodiment will be described with reference to FIGS. 12, 13, 14, and 15, each of which shows a relationship among the terminal 0215, the summary transmitting server system 0202, the detailed content transmitting server system 0203, and the management control server system 0205 illustrated in FIG. 2 or 3.

It is assumed for convenience of description that the detailed content transmitting server system and the management control server system exist over the Internet, and the detailed content transmitting server system, the summary transmitting server system, and the management control server system communicate with one another through, what is called a Web interface.

That is, each of the summary transmitting server system and the detailed content transmitting server system has its own Web application server that periodically performs Web access to the Web server provided in the management control server system and functions as a communication interface, so as to receive any information from the management control server system for its own system or transmitting any information from its own system to the management control server system. It may be configured so that the application processing unit of each system directly communicates with the application processing unit of the others without providing the Web server to the management control server system.

### First Embodiment

In connection with an operation where the management control server system 0205 collects the access information on the fact that the user carrying his own terminal has received summary content of an interested genre and has actually accessed the detailed content to receive the detailed content, and displays the advertisement content or changes the current advertisement content to another one based on the collected access information for the unspecified users 0307 that are located near the advertisement displaying device regardless of whether they carry their own terminal or not, the summary transmitting server system, the detailed content transmitting server system, the management control server system, and the terminal will be described below, wherein a genre of the user carrying his own terminal is registered and managed to/by the terminal.

FIG. 4 is a diagram illustrating an exemplary construction of the main components which include a summary transmitting server system 0202, a management control server system 0205, and a detailed content transmitting server system 0203, according to the first embodiment of the present invention.

Referring to FIG. 4, the management control server system 0205 includes a Web server, an application server 0402, and a data management server 0401. In FIG. 4, the Web server includes an intra Web server 0403, a Web server 0405 for summary, a Web server 0404 for advertisement, and a Web server 0406 for collection. These Web servers function to perform input/output of system information with other devices. Even though the construction is shown in FIG. 4, where the Web servers are provided separately, the present invention is not limited thereto. For example, the Web servers may be implemented as a single server, for example by providing four different units having the same functions as those of the Web servers 0403, 0404, 0405, and 0406, with each of the units assigned each different URL (if each of the Web server 0403, 0404, 0405, and 0406 have URLs different from that of the others, the Web servers 0403, 0404, 0405, and 0406 may be implemented as a single server). The management control server system 0402 functions as an application interface between each of the four Web servers and the summary/advertisement content management server 0401 assigning a location as a data management server.

As shown in FIG. 4, the management control server system 0402 includes an intra processing unit 0408, an advertisement transmission scheduler 0409, a summary transmission scheduler 0410, and a collection processing unit 0411. In particular, the intra processing unit 0408 performs input/output for the intra Web server 0403, that is, a writing/reading process for the summary/advertisement content management server 0401. The summary transmission scheduler 0410 performs an input/output process for the Web server 0405 for summary (a writing/reading process for the summary/advertisement content management server 0401) including the collection processing unit 0411. Similarly, the summary transmission scheduler 0409 performs an input/output process for the Web server 0404 for advertisement (a writing/reading process for the summary/advertisement content management server 0401) including the collection processing unit 0411. The collection processing unit 0411 performs an input/output process for the Web server 0405 for collection (a writing/reading process for the summary/advertisement content management server 0401) including the summary transmission scheduler 0410 and the advertisement transmission scheduler.

The Intra Web server 0403 provides an input IF (GUI), which is necessary when the operator registers the summary content and the advertisement content received from the content provider to the management control server system 0205, an output IF (GUI), which is necessary when the operator identifies the registration state, and an input/output IF (GUI), which is necessary when the operator defines a genre system classifying the content, the position of the summary transmitting server system distributed in various locations, and registers and identifies the configuration of devices connected to the summary transmitting server system (for example, structural state of a connection between the access point 0106 and the advertisement displaying device 0212).

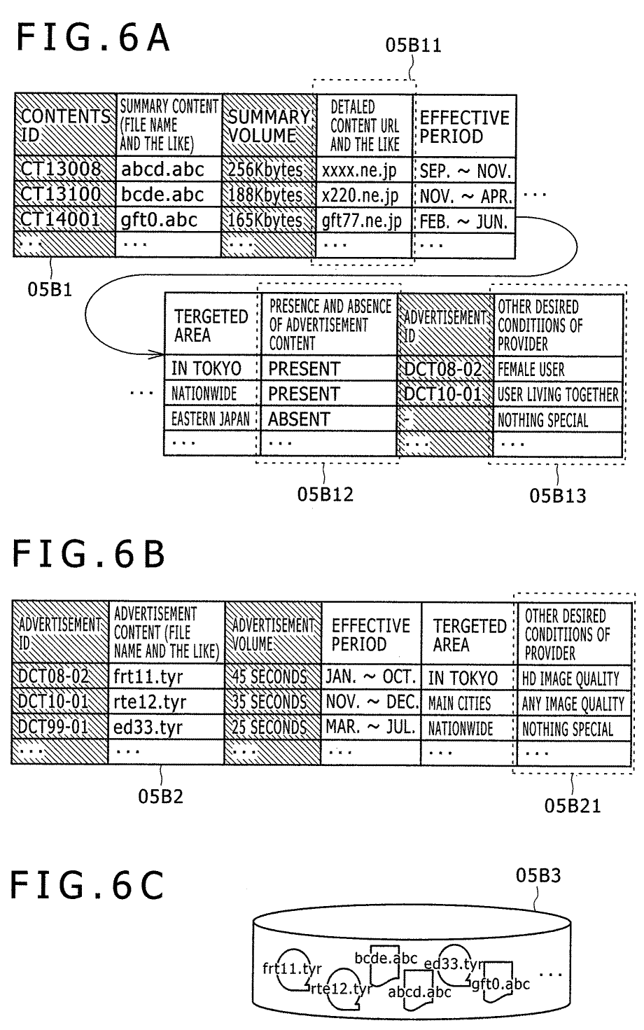

Further, the Intra web server 0403 provides an input/output IF (GUI), which is necessary when the operator or content provider inputs or identifies various conditions associated with the provision of a desired content of the content provider. These various conditions correspond to an effective period of the content provision, a targeted area, etc., shown in FIGS. 6A to 6C, to be described below, but are not limited thereto. That is, there are various conditions to consider. The management control server system 0205 periodically generates a schedule associated with the transmission of the summary content and the display of the advertisement content for each and every summary transmitting server system.

A registered terminal 0407 refers to a terminal used in registering and identifying the management control server system 0205 by the operator, such as a PC (Personal Computer). The registered terminal 0407 shown in FIG. 4 is connected to the Intra Web server through an Intranet line.

Even though it is illustrated in FIG. 4 that the Intra Web server 0403 is responsible for registering the summary/advertisement content to the management control server system 0205, the definition of a genre or registration of the location of the summary transmitting server system and the configuration of the devices, as well as the content provision conditions of the content provider, the present invention is not limited thereto. For example, the content provider can perform registration through the Internet from his own device corresponding to the registered terminal 0407 to the management control server system 0205. In actuality, this may be more common and convenient for the content provider. In this case, an additional Web server dedicated for the content provider corresponding to the Intra Web server 0403 may be independently provided as a part of the management control server system 0205, wherein the Web server may be accessed through the Internet.

The information (including the summary/advertisement content itself) registered in the management control server system 0205 is managed by the summary/advertisement content management server 0401 shown in FIG. 4. The operator or content provider may access the Intra Web server 0403 from the registered terminal 0407, for example, by using a browser, and register various types of information and perform a reading process to identify the registered information according to a screen provided by the Intra Web server 0403. The registration and reading processes by the operator or content provider is for the summary/advertisement content management server 0401, and these processes may be performed by the Intra processing unit 0408.

As such, the content or various information registered in the summary/advertisement content management server 040 is used for generating a schedule for transmission or display of the content by the management control application server 0402 based on the conditions such as the desired content provision area (desired, targeted area) of the summary content provider or time during which the content may be provided (effective period).

The schedule is generated for each and every one of the summary transmitting server systems distributed in various locations, and as shown in FIG. 4, the schedule concerning the transmission of the summary content is generated by the summary transmission scheduler 0410, the schedule concerning the transmission of the advertisement content by the advertisement transmission scheduler 0409.

Also, the generated schedules are all stored and read to/from the summary/advertisement content management server 0401. That is, the summary transmission scheduler 0410 periodically generates a schedule concerning the transmission of the summary content for each and every one of the summary transmitting server systems based on the information (including the summary content) registered in the summary/advertisement content management server 0401 through the Intra processing unit 0408, and stores the generated schedule to the summary/advertisement content management server 0401.

Similarly, the advertisement transmission scheduler 0409 periodically generates a schedule concerning the display of the advertisement content for each and every summary transmitting server system based on the information (including the advertisement content) registered in the summary/advertisement content management server 0401 through the Intra processing unit 0408, and stores the generated schedule to the summary/advertisement content management server 0401. The periodic generation of schedule means, for example, generating the schedule hourly, half-day, daily, etc.

Each schedule generated by the advertisement transmission scheduler 0409 or summary transmission scheduler 0410 and stored in the summary/advertisement content management server 0401 is subjected to a rescheduling process in response to an instruction from the collection processing unit 0411 as shown in FIG. 4. The instruction for rescheduling is received from the collection processing unit 0411 to either or both of the summary transmission schedulers 0410 or/and the advertisement transmission scheduler 0409, each scheduling unit of the advertisement transmission scheduler 0409 and the summary transmission scheduler 0410 reads out the schedule that has been generated by its own system and stored in the summary/advertisement content management server 0401 and performs a rescheduling process on the read schedule, then storing the resultant schedule back in the summary/advertisement content management server 0401.

Such a routine-like rescheduling process is processed for example in the following relationship. For example, a pre-schedule for the next day is previously generated everyday, and the generated pre-schedule for the next day is rescheduled every hour in the corresponding day. Further, it is possible to shorten or lengthen the time interval, to shorten or lengthen the generating timing of the pre-schedule, or plural days prescheduled may be generated at one time. The plural days pre-scheduled mean, for example, generating the next day, the day after the next day, two days after the next day, and so on, at one time, as in the above example.

Here, it should be noted that, in the example of FIG. 4, each scheduling unit of the advertisement transmission scheduler 0409 and the summary transmission scheduler 0410 performs rescheduling on the schedule generated once in response to the instruction of the collection processing unit 0411, and stores the resultant reschedule back to the summary/advertisement content management server 0401.

The instruction to the advertisement transmission scheduler 0409 and the summary transmission scheduler for rescheduling is generated from the collection processing unit 0411 as follows. The collection processing unit 0411 stores information (access information) periodically collected from the detailed content transmitting server 0203 in the summary/advertisement content management server 0401. The access information is collected from each of the existing plurality of detailed content transmitting server systems. Similarly, the collection processing unit 0411 reads out the stored access information, and produces, for example popularity degree of the detailed content that is provided to the detailed content transmitting server system.

As mentioned above, the access information collected from the detailed content transmitting server system means information on the number of facts when a user, who has received the summary content, was attracted by the summary content to actually access the detailed content transmitting server system, which was aggregated during any time interval by the detailed content transmitting server system. In this calculation process, the detailed content transmitting server system receives information on receiving of the summary content from the terminal 0215 upon access of the terminal 0215.

For example, the detailed content transmitting server system 0203 may receive the information such as information on position and time where/when the summary content has been collected from the terminal 0215 that has accessed the system 0203. In addition, the detailed content transmitting server system 0203 may also receive the user's attribute information from their terminal 0215.

This may be implemented, for example, as follows: the user carrying the terminal 0215 is a member of a membership group, a membership ID is issued to the user, attribute information of the user (for example, attribute information such as his/her family, gender, age, etc.) is previously registered in the system, and when the terminal 0215 tries to gain access to the summary transmitting server system 0202 and the detailed content transmitting server system 0203, the terminal is required to offer his membership ID, and the ID information is collected as the access information. The collection processing unit 0411 periodically collects the information such as location information, time information, and membership ID (attribute information of the accessing user) from the overall detailed content transmitting server systems based on the number of accesses (when the terminal has accessed the detailed content transmitting server system), and stores in the summary/advertisement content management server 0401.

What the collection processing unit 0411 produces, for example popularity degree based on the collected access information means the following process. When it is assumed that any time interval during which the detailed content transmitting server system aggregates the access information from its own system is equal to a periodic time interval during which the management control server system collects the access information from the entire detailed content transmitting server systems, it means evaluating the amount of popularity degree, for example by determining on what content has the maximum amount of concentration by access.

Further, it is possible to perform an analysis on various users' trends as well as popularity degree by collecting information such as the membership ID information (user's attribute information that is conditionally provided from the membership ID), location information (information on the location in which the summary content may be obtained), and time information (time when the summary content is obtained). For example, it is possible to easily compute the gender and age of the user who has had access, as well as popular location in which the summary content may be obtained. It is further possible to classify various categories, such as genre, to determine what genre has popularity, so that other contents in the same genre may increase in popularity. It should be noted that this user-oriented analysis processing method or know-how is not essential for the present invention. However, it is critical in FIG. 4 when the collection processing unit 0411 performs the above process so as to be able to send instructions to the summary transmission scheduler 0410 and the advertisement transmitting scheduler 0409 based on the result.

In response to the instruction from the collection processing unit 0411, the scheduler in FIG. 4 (i.e. advertisement transmission scheduler 0409 and summary transmission scheduler 0410) reads out the schedule generated by the scheduler from the summary/advertisement content management server 0401, and modifies/changes (regenerates) the previous schedule in order to transmit or display the content having high popularity degree, or so that the schedule becomes the display schedule for other advertisement contents of the same genre as the content having the high popularity degree, and then stores the modified/changed (rescheduled) schedule in the summary/advertisement content management server 0401.

In FIG. 4, the summary transmitting server system 0202 receives the latest schedule for its own system from the management control server system 0205, and transmits the summary content to the terminal 0215 that has accessed the individual system or displays the advertisement content on the advertisement displaying device 0212 connected to the individual system based on the latest schedule. In particular, in FIG. 4, the summary transmitting application server 0413 is responsible for this process.

In FIG. 4, the summary transmitting application server 0413 for the summary content periodically gains access to the Web server 0405 for a summary included in the management control server system 0205, so as to provide the transmission schedule concerning the summary content, and receives the schedule for the summary content for the individual system. Also, the summary transmitting application server 0413 receives the summary content also, which is described in the schedule, as well as the schedule. The summary content described in the schedule refers to, for example, a file name. Here, the summary transmitting processing unit 0416 receives a file corresponding to the file name described in the obtained schedule from the Web server 0405 for a summary together with the schedule. The file itself is also stored in the summary/advertisement content transmitting server 0401 of the management control server system 0205 as described above.

The individual system receives the summary content and the schedule concerning the summary content, which is performed by the summary transmitting application server 0413, in particular, the summary transmitting processing unit 0416. As described above, the latest schedule from the summary transmission scheduler 0410 and the collection processing unit 0411 is stored in the summary/advertisement content management server 0401 of the management control server system 0205. The summary transmitting processing unit 0416 periodically accesses the Web server 0405 for a summary and receives the schedule and summary content itself for the individual system through the Web server 0405 for a summary.

Upon access to the Web server 0405 for a summary, the summary transmitting server system 0202 may provide the management control server system 0205 with the access information on the terminal 0215 that has accessed the individual system. Here, the summary transmitting server system 0202 may provide the access information with the management control server system 0205 at a time different from the time the summary content and the schedule concerning the summary content is received. Even when the summary transmitting server system provides the access information, in a case where there exists an access point, such as an access point 0106 connected to the individual system, the summary transmitting server system 0202 may also aggregate the access information of the terminal 0215 during any time interval as the detailed content transmitting server system does.

The summary transmitting server system 0202 provides the aggregated information to the management control server system 0205 like that of the detailed content transmitting server system 0203. The aggregated information is periodically collected by the entire summary transmitting server systems 0202 that are distributed in various locations similarly to the detailed content transmitting server system 0203. The collecting process may be performed by the summary transmitting processing unit 0416 having periodic access to the web serve 0405 for summary as shown in FIG.4. The access information counted by the summary transmitting server system 0202 at any time interval is provided to the management control server system 0205 by the summary transmitting processing unit 0416 that has accessed the Web server 0405 for a summary. In FIG. 4, the access information provided to the Web server 0405 for a summary is stored in the summary/advertisement content management server 0401 of the management control server system 0205 by the summary transmission scheduler 0410. The stored access information, which has been aggregated by the summary transmitting server system 0202, is read out by the collection processing unit 0411 and the read access information is used, for example, for calculating the popularity degree.

By doing so, for example a popularity degree may be produced by the collection processing unit 0411 not only by calculating the number of accesses to the detailed content transmitting server system, but also by calculating the number of actual access to the detailed content relative to the number of transmissions of the summary content. This corresponds to calculation of an evaluating parameter, such as the actual number of derivations relative to the total number of summary provision.

It should be noted that the access information of the terminal 0215 of the summary transmitting server system 0202 may be collected by the management control server system 0205. That is, both the access information of the terminal of the summary transmitting server system 0202 and the access information of the terminal of the detailed transmitting server system 0203 may be collected by the management control server system 0205, which in turn performs a rescheduling process using the information for generating the latest schedule. It should be noted that the rescheduled result (that is, the latest schedule) is transmitted from the management control server system 0205 to the summary transmitting server system 0202, and based on the latest schedule, the summary transmitting server system 0202 provides the summary content or display the advertisement content on the advertisement displaying device (or changes the displayed advertisement content into another one).

The summary content and the schedule concerning the summary content obtained by the summary transmitting processing unit 0416 for the individual system is stored in the area provision content management server 0412 of the summary transmitting server system 0202 shown in FIG. 4. Similarly, the stored summary content and schedule concerning the summary content are similarly read out by the summary processing unit 0416 and the summary content corresponding to the read-out schedule is provided to the terminal 0215. In a case where there exists one or more access point 0106 that is configured to be connected to the summary transmitting server system 0202, providing the summary content to the terminal 0215 is performed by the terminal 0215 accessing the summary Web server 0414 using a terminal through the access point 0106 shown in FIG.4. If there is an access from the terminal 0215 to the summary Web server 0414 using a terminal, the summary Web server 0414 using a terminal instructs the summary transmitting processing unit 0416 in the summary transmitting application server 0413 to read out the latest schedule concerning the summary content stored in the area content management server 0412 and sequentially read the summary contents according to the schedule. The content read out by the summary transmitting processing unit 0416 is provided to the terminal 0215 through the summary Web server 0414 for terminal.

In the meantime, similar to the summary content in FIG. 4, with respect to the advertisement content, the summary transmitting application server 0413 periodically gains access to the Web server 0404 for advertisement to receive a schedule concerning the advertisement content for the individual system. In addition, the summary transmitting application server 0413 receives the advertisement content itself that has been described in the schedule. In FIG. 4, the Web server 0404 for advertisement is prepared in the management control server system 0205, so as to provide the transmitting advertisement content and the schedule concerning the advertisement content to the summary transmitting server system 0202.

Similarly to the summary content, a relationship is established between the advertisement content and the schedule concerning display of the advertisement content, for example, by the description of the file name. The individual system receives the advertisement content and the schedule concerning the advertisement content, which is performed by the summary transmitting application server 0413, in particular, the advertisement transmitting processing unit 0415. The advertisement transmitting processing unit 0415 periodically gains access to the Web server 0404 for advertisement and receives the schedule and advertisement content itself for the individual system through the Web server 0404 for advertisement.

Here, there exist two types of accesses of the summary transmitting application server 0413 to the management control server system 0205. The first type is a periodic access of the summary transmitting processing unit 0416 to the Web server 0405 for a summary, and the second type is a periodic access of the advertisement transmitting processing unit 0415 to the Web server 0404 for advertisement. In the former type, the means of access is performed generally two ways: one is receiving of the transmission schedule and content concerning the summary content and the other is providing of the access information of the terminal to the management control server system 0205. In this exemplary embodiment, providing access information of the terminal to the management control server system 0205 may be performed or not. More specifically, in a case where the management control server system 0205 requires the access information aggregated by the summary transmitting server system 0202 as base information for the above-mentioned rescheduling process, the access information is received by the management control server system 0205, otherwise the access information is not received by the management control server system 0205. It is also possible that in the latter case, i.e., in a case where the access information is not required as the base information, the access information may not be aggregated in the summary transmitting server system 0202. In the meantime, the periodic access is essentially performed in this exemplary embodiment for receiving the transmission schedule and the content concerning the summary content, and also the periodic access is inevitably carried out in the exemplary embodiment for receiving the display schedule and the content concerning the advertisement content. The two periodic accesses for the summary content and the advertisement content are performed, for example, at the same time and at the same time intervals. The two periodic accesses may also be performed at different timings and at the different time intervals.

As such, in FIG. 4, the management control server system separates the information (schedule and the contents itself) into two, i.e. for a summary and advertisement, before providing the information to the summary transmitting server system 0202. That is, as exemplified in FIG. 4, the summary transmitting server system 0202 periodically gains access on each of the Web server 0405 for summary and the Web server 0404 for advertisement and separates the schedule and the content itself for the individual system 0202 before providing the schedule and content itself to the individual system 0202. It may be further possible the periodic access of the summary transmitting server system 0202 to the Web server 0404 for a summary and the Web server 0404 for advertisement is continuously performed, while the summary transmitting server system 0202 has only one access to a single Web server that has the same URL in order to receive the four different types of information, such as the summary content and its schedule, and the advertisement content and its schedule, without the Web server being separated into the Web server 0405 for summary and the Web server 0404 for advertisement.

The advertisement content and the schedule concerning the advertisement content received for the individual system by the summary transmitting application server 0413, (especially the advertisement transmitting processing unit 0415), are stored in the area provision content management server 0412 of the summary transmitting server system 0202 in FIG. 4. The stored advertisement content and the schedule concerning the advertisement content are similarly read out by the advertisement transmitting processing unit 0415 and displayed on the advertisement displaying device 0212 based on the read-out schedule. That is, at the time of receiving the latest schedule concerning the advertisement content and storing the latest schedule in the area provision content management server 0412, the advertisement content corresponding to the received latest schedule is displayed on the advertisement displaying device 0212. Accordingly, the user who has watched the advertisement displaying device 0212 (user 0307 shown in FIG. 3) can recognize the change in the advertisement content.

Even though there is no access point or advertisement displaying device connected to the summary transmitting server system 0202, there may exist schedules concerning the summary content and the advertisement content in the summary transmitting server system 0202. In this case, there may not exist contents describing the schedule (the schedule generated for each and every summary transmitting server system 0202) generated from the management control server system 0205. At this time, the summary transmitting server system 0202 only receives the schedule generated for the individual system without receiving the content itself, since no contents were included in the schedule, and thus stores only the schedule in the area provision content management server 0412 in FIG. 4. However, the present invention is not limited thereto, and rather many other methods may be used. For example, the summary transmitting server system 0202 may manage a connection configuration for the individual system so that if no advertisement displaying device is connected to the summary transmitting server system 0202, the advertisement transmitting processing unit 0415 is not activated in FIG. 4. As such, even though no access point or advertisement displaying device is connected to the summary transmitting server system 0202, the function, configuration, and operation of the summary transmitting server system 0202 may still remain as those in FIG. 4, but without being changed separately into function, configuration, and operation.

In a case where after receiving a summary content, the user tries to access the detailed content, the terminal 0215 gains access to the Web server 0419 for contents of the detailed content transmitting server system 0203, as shown in FIG. 4. The detailed content to be provided to the user through the Web server 0419 for contents that has been introduced in the summary content received from the summary transmitting server system 0202. For example, launching of brand new clothes from ABC company to establish the relationship between the summary content and the detailed content, the clothes have been released to correspond to the summary content, and its details, for example, such as the name of shops selling the clothes, sale prices, stocks, and whether the clothes are provided for each and every size, correspond to the detailed content.

Upon access of the terminal 0215 to the Web server 0419 for content, the terminal 0215 provides the information, when the terminal 0215 received the summary content, (hereinafter, referred to as “receiving-related information”) to the detailed content transmitting server 0203. The receiving-related information is provided from the terminal 0215 to the detailed content transmitting server 0203 through the Web server 0419 for content. The provided receiving-related information is stored in the detailed content management server 0417 by the application server 0418 in FIG. 4. In FIG. 4, the detailed content management server 0417 also stores the detailed content prepared by the summary content provider. In connection with registration of the detailed content to the detailed content management server 0417, the detailed content is previously registered to the detailed content management server 0417 by the content provider, and the detailed content prepared by the summary content provider is read out of the detailed content management server 0417 by the application server 0418 by accessing of the terminal 0215 to the Web server 0419 for content, and then provided to the terminal through the Web server 0419 for content.

During the access from the terminal 0215 to the Web server 0419 for content, the receiving of the related information stored in the detailed content management server 0417 is collected as the access information (specifically, a component of the access information) that is periodically collected by the management control server system 0205 from the overall detailed content transmitting server systems 0203, in which plural transmitting server systems may exists over the Internet. In this connection, in FIG. 4, the application server 0418 reads out the access information from the detailed content management server 0417 and periodically accesses the Web server 0406 for collection in the management control server system 0205 to provide the access information (including the receiving of the related information) to the management control server system 0205. In FIG. 4 similar to the access information, receiving of the related information may be aggregated over a constant time in the detailed content transmitting server system 0203, and the aggregated receiving-related information is collected in the management control server system 0205. The aggregation of the receiving-related information in the detailed content transmitting server system 0203 and the periodic access to the Web server 0406 for collection may be performed, for example, at the same time interval.

Hereinafter, the access information and the receiving-related information that have been described so far will be summarized. Two types of access information have been described, and these types of access information are all collected periodically by the management control server system 0205. One of them is the access information that is counted at any time interval by the summary transmitting server system 0202, and the other is the access information that is counted at any time interval by the detailed content transmitting server system 0203. In this exemplary embodiment, it does not matter what kind of access information is used by the management control server system 0205 to generate a reschedule.

In generating the reschedule, there are two cases: one only using the access information collected from the detailed content transmitting server system, and the other using the access information collected from both the summary transmitting server system 0202 and the detailed content transmitting server system 0203. Specifically, in the former case, for example, a popular content or popular genre is produced by considering the number of actual accesses to the detailed content as a basic evaluation parameter, and a reschedule is generated. In the latter case, for example, popular content or popular genre is produced by considering the actual number of derivations relative to the total number of provisions of the summary content as a basic evaluation parameter, and a reschedule is generated. It should be noted that the number of accesses is not used for generating the reschedule (that is, the number of accesses is merely one basic evaluation parameter), but any other information may be used as the evaluation parameter, for example, information on receiving location of the summary content, information on receiving time, and user's attribute information (for example such information as age, gender, and family construction under a membership system) as well as the number of access. The information that can be used as the evaluation parameter, i.e. the number of accesses and other information, such as location information, receiving time information, and user's attribute information that may be added to the number of accesses, may be integrally considered as the access information.

The receiving-related information provided from the terminal 0215 to the detailed transmitting server system 0203 upon access of the terminal 0215 to the detailed content transmitting server system 0203 refers to information that may become a component (one construction) of the access information counted at any time by the detailed content transmitting server system 0203. The access information counted at any time by the detailed content transmitting server system 0203 may be generally classified into two information components. One is an information component generated (provided) by the detailed content transmitting server system 0203, and the other is an information component received from the terminal 0215. The former information component includes, for example, the number of access, information on access time to the detailed content transmitting server 0203, and information on residence time in the detailed content transmitting server 0203, and the latter information component includes, for example, receiving location of the summary content (i.e. which summary transmitting server system 0202 the accessing user has received the summary content from), information on receiving time of the summary content (i.e. when the summary content has been received), and membership ID (i.e. the ID necessary to make any association with the user attribute information, such as age, gender, and family construction) in a case where the user is affiliated with a membership. The receiving-related information refers to any information corresponding to the latter information component.

It should be noted that the latter information component may become unnecessary. In this case, however, the information component of the access information aggregated by the detailed content transmitting server system 0203 is limited to, for example, the number of accesses, the time information of the access (to the detailed content transmitting server 0203), and the information on residence time (in the detailed content transmitting server 0203), and for example a popular content or genre is produced using the limited information component (in collecting the access information by the management control server system 0205 and generating a reschedule by the management control server system 0205). By adding the information component received from the terminal (which corresponds to the latter information component, i.e. receiving-related information) to the (former) information component, the variation in producing popular content or genre is increased, and an advertisement changing effect may be anticipated in respects to the reschedule.

The phrase “the variation in producing various popular content or genre is increased and an advertisement changing effect may be anticipated in respects to the reschedule” means, for example, that it can be known which one of the users has selected most often out of the summary transmitting server systems 0202 distributed in various locations by aggregating/collecting the information on location, in which the user has received the summary content and added the aggregated/collected result to the number of accesses, that is, where the most popular summary transmitting server system is located. Here, the popular summary transmitting server system may be known by considering the access information received from the summary transmitting server systems 0202 in determining the most popular summary transmitting server system 0202, i.e. considering the actual number of derivations relative to the total number of provisions of the summary content. The determined result may be reflected by changing the advertisement content displayed on the advertisement displaying device connected to the popular summary transmitting server system, i.e., generating a reschedule, and this enables advertisement to change to meet the user's needs at various locations. From the viewpoint of the content provider or content transmission operator, this means that it is possible to analyze user's trends or inclinations more suitable for the local, which may lead to a promotion of advertisement.

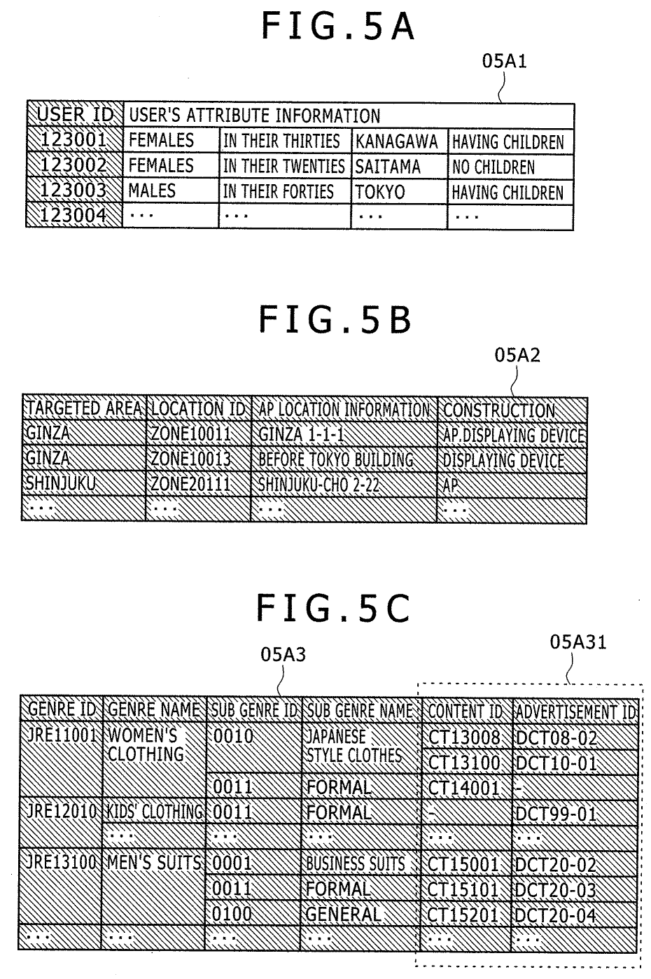

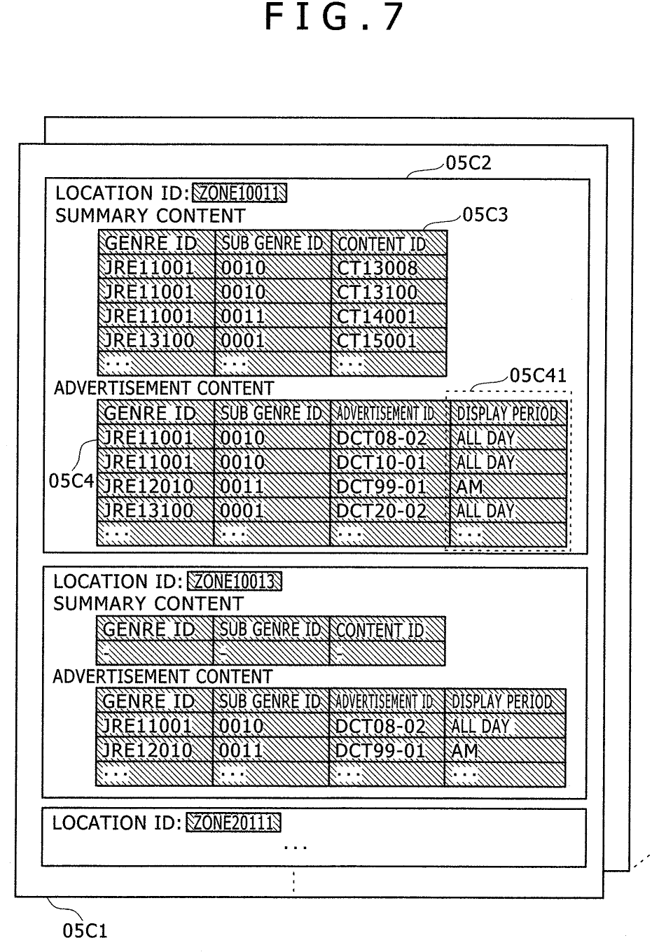

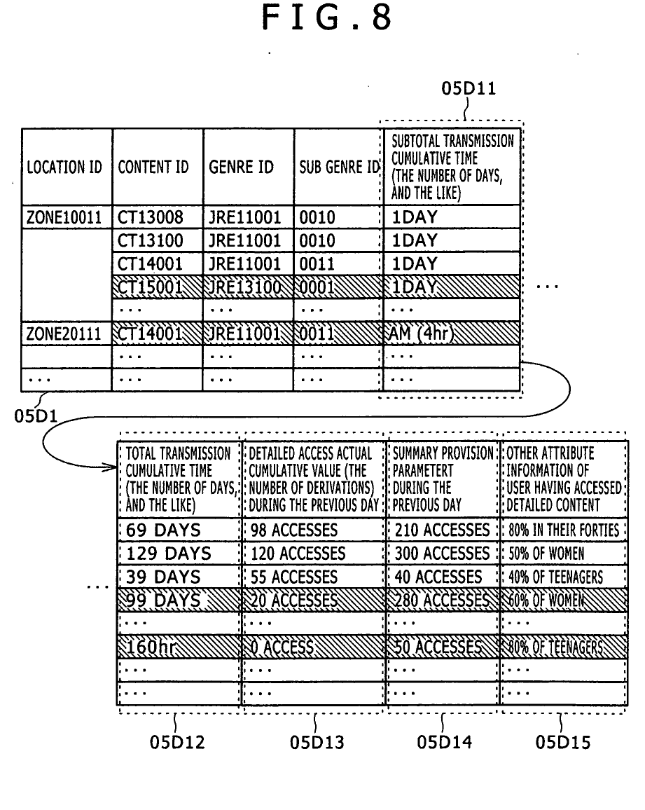

Next, FIGS. 5A to 5C, FIGS. 6A to 6C, FIG. 8, and FIG. 8 will be described. All four drawings exemplify a storing of information and the content itself stored in the summary/advertisement content management server 0401 in FIG. 4. Specifically, FIGS. 5A to 5C is a diagram illustrating an example of an information table (information group) corresponding to the basic information (information associated with transmitting the summary content or advertisement content), FIGS. 6A to 6C is a diagram illustrating an example of an information table (information group) associated with the summary content or advertisement content and exemplifies storing of the content itself, FIG. 7 is a diagram illustrating an example of an information table (information group) corresponding to the transmission schedule concerning the content transmitted from the summary transmitting server system 0202 and the display schedule of the advertisement content, and FIG. 8 is a diagram illustrating an example of a collection (counted information) table (information group) generated by the management control server system 0205 based on the access information that is periodically collected by the management control server system 0205.

FIG. 5A shows an example of managing a user's attribute information, such as user ID (membership ID), gender, age, family construction, and address, as a user management table 05A1. This user management table 05A1 is a table managed by the management control server system 0205 in a case where the user carrying the terminal has a membership. Accordingly, unless the user has a membership, the table 05A1 would not exist. However, the registration and management can be performed even if the user has no membership. Further, the registration and management of the user's attribute information in a membership system enable a statistical analysis of a relationship between the attribute information of the user that has accessed the detailed content transmitting server system 0203 and, for example, the popular content, as well as analysis of user's needs or trends concerning specified products offered in the detailed content. The user's attribute information may be variously provided, other than the ones exemplified in the table 05A1, but at this time further descriptions will be omitted. All the user's attribute information is not necessarily managed. In this case, only the user ID may be managed. The user ID contained in the user management table 05A1 is information that is generated by the management control server system 0205, and assigned to each user or each terminal.

FIG. 5B shows an example of managing a structure of access pointers and advertisement displaying devices connected to the summary transmitting server system 0202 and the installation location of the summary transmitting server system 0202 as an AP management table 05A2. Location IDs such as ZONE 10011, which are assigned to the summary transmitting server system, are managed in the AP management table 05A2. The location IDs are generated from the management control server system 0205. One location ID corresponds to one summary transmitting server system 0202. The AP management table 05A2 manages the structure of the access points and advertisement displaying devices connected to the summary transmitting server system 0202. For example, the location ID ZONE 10011 in the AP management table 05A2 refers to a case where both an access pointer and an advertisement displaying device are connected to the summary transmitting server system 0202. Further, the location ID ZONE 10013 refers to a case where only the advertisement displaying device is connected to the summary transmitting server system 0202 without being connected to any access pointer, the location ID ZONE 20111 where only the access pointer is connected to the summary transmitting server system 0202 without being connected to any advertisement displaying device. It may also be possible that plural advertisement displaying devices is connected to one summary transmitting server system 0202. In this case, the plural different location IDs may be assigned to the summary transmitting server system. The summary transmitting server system 0202 manages the location IDs assigned to the individual system, and the management control server system 0205 generates or regenerates each schedule for each and every location ID. In addition, the summary transmitting server system 0202 receives a schedule prior to the individual system, i.e. the location ID assigned to the individual system from the management control server system 0205. By doing so, even if plural advertisement displaying devices are connected to a single summary transmitting server system 0202, the summary transmitting server system 0202 may perform an advertisement changing process with each schedule for each advertisement displaying device.

With respect to information communication between the summary transmitting server system 0202 and the management control server system 0205, communication of information is performed based on the location ID that is generated and managed in the AP management table 05A2. In connection with a schedule table 05C1 and a collection table 05D1 to be described below, the three tables 05A1, 05C1, and 05D1 are associated with each other based on the location ID, and various types of information described in the three information tables are managed by the management control server system 0205. It should be noted that the information management may be performed by other methods and table construction other than the location ID, and the location ID may be replaced by, for example, a device ID or an Internet address for performing the information management and information communication between the summary transmitting server system 0202 and the management control server system 0205.

The information, such as a targeted area, AP location information, and structure, in the AP management table 05A2 is registered in the management control server system 0205 by the system operator or his operator. The registration of the location ID in the summary transmitting server system 0202 may be previously set prior to installation of the summary transmitting server system, and the setup of the location ID in the summary transmitting server system 0202 may be carried out to correspond to the summary transmitting application server 0413 in FIG. 4 (in FIG. 4, the location ID may be registered and managed as a setup file in the area provision content management server 0412).

FIG. 5C shows an example of managing the summary content or advertisement content provided by the advertisement provider, with the summary content or advertisement content categorized as each genre, as a genre table 05A3. The categorized genre may be further separated into sub genres in the genre table 05A3. Even though the genre table 05A3 includes genres and sub genres, the present invention is not limited thereto, and other various categorizations may be available (two categories, such as genre and sub genre, are exemplified herein, and thus the exemplary information tables shown in FIGS. 7 and 8 to be described below will include genres and sub genres).

The content ID in the genre table 05A3 refers to an ID assigned to the summary content provided by the advertisement provider, and the advertisement ID is an ID assigned to the advertisement content provided by the advertisement provider. These two IDs are assigned by the management control server system 0205 for identifying and managing the content. The assignment is carried out when any content is provided by the advertisement provider.

For example, in FIG. 4, the content ID is assigned to the summary content when the system operator or operator registers the content to the summary/advertisement content management server 0401 using the registered terminal 0407, the Intra Web server 0403, and the Intra processing unit 0408. It may also be possible, as shown in FIG. 4, the advertisement provider (content provider) registers the content from its individual device corresponding to the registered terminal 0407 to the management control server system 0205, for example through the Internet line. In this case, also, the content ID is assigned when the advertisement provider registers the advertisement content.

The content provided by the advertisement provider may include only the advertisement content displayed on the advertisement displaying device, only the summary content provided to the terminal (here, it should be noted that the summary content needs to be prepared together with the detailed content by the advertisement provider), or both the advertisement content and the summary content that are displayed on the advertisement displaying device and provided to the terminal, respectively). In the genre table 05A3, reference numeral 05A31 exemplifies this situation. Reference numeral 05A31 shows when only the summary content is provided for the category “women's clothing and formal”, only the advertisement content for the category “kids' clothing and formal”, and both the summary content and the advertisement content for the category “women's clothing and Japanese style clothing” from the advertisement provider. As a result, it can be seen through reference numeral 05A31 that two summary contents and two advertisement contents are provided for the category “women's clothing and Japanese style clothing”.

The definition of category, such as “women's clothing” or “Japanese style clothing”, is previously registered to the management control server system 0205 by the system operator or operator. The category definition is added in the summary/advertisement content management server 0401 through the registered terminal 0407, the Intra Web server 0403, and the Intra processing unit 0408, in FIG. 4. When the system operator or operator receives the content from the advertisement operator (or the advertisement provider provides the content, for example, through the Internet line), the content is registered to the management control server system 0205 as described above. Upon registration of the content, it is also set which genre (category) the content belongs to, so that the genre table 05A3 may be generated or updated. The update of the genre table 05A3 may also be performed by the system operator or operator while performing addition or modification of the category definition.

FIG. 6A shows an example of a situation managing an information group associated with the summary content as a content table 05B1 by the management control server system 0205, and FIG. 6B shows an example of a situation managing an information group associated with the advertisement content as an advertisement table 05B2 by the management control server system 0205.

Out of the exemplary information described in the content table 05B1 of FIG. 6A, the information items that have no hatching are registered to the management control server system 0205 together with the summary content when the summary content to be transmitted to the terminal is registered to the management control server system 0205 by the system operator or his operator, or advertisement provider.

The information item indicated by, for example, “abcd. abc” in the content table 05B1 refers to the summary content itself, in particular, the file name of the summary content. The state where the summary content itself is stored in the management control server system 0205 is shown as reference numeral 05B3 in FIG. 6C. Herein, the phrase “storing in the management control server system 0205” specifically means storing in the summary/advertisement content management server 0401 of the management control server system 0205 in FIG. 4.

The detailed content indicated by reference numeral 05B11 refers to any information on the detailed content provided by the detailed content transmitting server system 0203, for example such as a URL value. That is, FIG. 6A shows a state where the management control server system 0205 manages correspondence between the summary content and the detailed content with the content table 05B1.

The effective period of the content table 05B1 is a desired transmission period during which the summary content is transmitted, and this corresponds to one of the provisional conditions of the advertisement provider. However, the effective period can be omitted from the content table 05B1. In this case, the information item corresponding to the effective period would be removed from the table 05B1. Similarly, the targeted area means a desired transmission area to which the summary content is transmitted, and this also corresponds to one of the provisional conditions of the advertisement provider. This information item, i.e. the targeted area, can be removed from the table 05B1.

The information item indicated by reference numeral 05B12 refers to whether the advertisement content is also provided along with the summary content. If the advertisement content is also provided together with the summary content, the advertisement content and summary content are managed together, with the advertisement content having an advertisement ID that corresponds to the summary content having an ID, in the content table 05B1. Referring to FIG. 6A, in the content table 05B1, the summary content whose ID is CT13008 corresponds with the advertisement content whose advertisement ID is DCT08-02. Referring to FIGS. 6A to 6C, including the genre table 05A3 shown in FIG. 5C, the summary content, for example, such as a notification of releasing of new product associated with Japanese style women's clothing, is registered and provided to the management control server system 0205 together with registration and provision of the advertisement content, for example such as a promotion CM for the new Japanese style women's clothing.

Besides, various content provision conditions (information items) desired by the advertisement provider are managed in the content table 05B1. The reference numeral 05B13 represents this situation in the content table 05B1. For example, in a case where the user's attribute information is managed by the user management table 05A1 shown in FIG. 5A using a membership system, a diversity of desired conditions may be considered, for example, such as a condition where the summary content is provided only to the user living with his family and a condition where the summary content is provided only to female users. The information items (without the hatch lines) in the content table 05B1 correspond to provision conditions of the advertisement provider relating to the registered summary content, and mean the information items registered by the advertisement provider. Or, the information items (without the hatch lines) correspond to the information items registered by the system operator or operator who has been instructed by the advertisement provider. The content ID for identifying the summary content is assigned to the summary content by the management control server system 0205 while the information items (without the hatch lines) and the content itself are registered to the management control server system 0205. At this time, the management control server system 0205 also manages additive information, for example, volume (capacity) of the registered, and identifies the content in the table 05B1 simultaneously to the assignment of the ID.

When assigning the ID to the summary content, the management control server system 0205 subsequently selects (registers) genre information to which the content with the ID belongs, as described above, with respect to the system operator or operator, or advertisement provider. As a result, the genre table 05A3 shown in FIG. 5C is updated.

In the advertisement content table 05B2 shown in FIG. 6B, the information item that has a description such as “frt11.tyr”, refers to the advertisement content itself, in particular, a file name of the advertisement content, as in the summary content table 05B1 shown in FIG. 6A. The state where the advertisement content itself is stored in the management control server system 0205 is shown as reference numeral 05B3 in FIG. 6C. Herein, the phrase “storing in the management control server system 0205” specifically means storing in the summary/advertisement content management server 0401 of the management control server system 0205 in FIG. 4, similar to the summary content.

Out of the information items, the effective period and the targeted area are equal to those in the summary content table 05B1, and these represent provisional conditions desired by the advertisement content provider. Besides, a diversity of content provision conditions (information items) desired by the advertisement provider are managed in the advertisement table 05B2 as in the summary content table 05B1. Reference numeral 05B21 represents this situation. For example, a condition such as the quality of an image displayed on the advertisement displaying device can also be considered.

The information items (without the hatch lines) in the advertisement table 05B2 correspond to the provisional conditions of the advertisement provider relating to the registered advertisement content, and these refer to the information items registered by the advertisement provider as in the summary content table 05B1. Or, the information items correspond to the information items registered by the system operator or operator who has been instructed by the advertisement provider. The advertisement ID for identifying the advertisement content is assigned to the advertisement content by the management control server system 0205 while the information items (without the hatch lines) and the advertisement content itself are registered to the management control server system 0205. At this time, the management control server system 0205 also manages additive information, for example, volume (capacity or replay time) of the registered, and identifies the content in the advertisement table 05B2 simultaneously to the assignment of the ID.

In registering the advertisement content as in the summary content table 05B1, when assigning the ID to the advertisement content, the management control server system 0205 subsequently selects (registers) genre information to which the content with the advertisement ID belongs, as described above, with respect to the system operator or operator, or advertisement provider. As a result, the genre table 05A3 shown in FIG. 5C is updated.

Reference numeral 05B3 of FIG. 6C shows a state where the advertisement content and the summary content have been registered in the management control server system 0205. That is, reference numeral 05B3 shows a state where the summary content itself described in the summary content table 05B1 and the advertisement content itself described in the advertisement content table 05B2 have been stored in the management control server system 0205.

FIG. 7 shows an example of a transmission schedule table that is generated (or regenerated) and managed by the management control server system 0205. This transmission schedule table is generated (or regenerated) and managed by the management control server system 0205 for each and every summary transmitting server system 0202 that may be distributed in various locations. In FIG. 7, reference numeral 05C2 denotes a schedule for the summary transmitting server system 0202 whose location ID is ZONE 10011, reference numeral 05C3 denotes a transmission schedule for the summary transmitting server system 0202 whose location ID is ZONE 10011 relating to the summary content provided to the terminal, and reference numeral 05C4 denotes a display schedule for the summary transmitting server system 0202 whose location ID is ZONE 10011 relating to the advertisement content displayed on the advertisement displaying device.

As such, even though the transmission schedule and the display schedule are managed herein by using the location ID for managing each of the summary transmitting server systems 0202 as described above with reference to the AP management table 05A2 of FIG. 5B, the present invention is not limited thereto. For example, in a case where the summary transmitting server systems 0202 are identified, for example, by the device ID or Internet address, the schedule 05C2 may be generated (or regenerated) for each device ID or Internet address, and the two schedules such as reference numerals 05C1 and 05C2 may be managed for each device ID or Internet address.

Since the summary transmitting server system 0202 of ZONE 10011 is configured so that the advertisement displaying device and access pointer (AP) are connected to the summary transmitting server system 0202 as described in the advertisement table 05A2 of FIG. 5B, the schedule table for the system consists of a summary content table (indicated by reference numeral 05C2) provided from the access pointer to the terminal and advertisement content table (indicated by reference numeral 05C4) displayed on the advertisement displaying device. That is, the summary transmitting server system 0202 of ZONE 10011 receives the schedule 05C2 from the management control server system 0205, provides the summary content 05C3 to the access pointer connected with the summary transmitting server system 0202 of ZONE 10011, and displays the advertisement content 05C4 on the advertisement displaying device connected to the summary transmitting server system 0202 of ZONE 10011 for unspecified users. The advertisement content displayed on the advertisement displaying device may contain a display period as indicated by reference numeral 05C41 of FIG. 7. The summary transmitting server system 0202 of ZONE 10011, which has received the display schedule 05C4, displays one or more advertisement content satisfying the condition 05C41, for example, in a sequential or random manner (the contents except for the advertisement content indicated by the advertisement ID DCT99-01 are displayed sequentially or randomly at any time during the afternoon (P.M.) in the example of the display schedule 05C4).

In the meantime, since the summary transmitting server system 0202 of ZONE ID 10013 is configured so that only the advertisement displaying device is connected to the summary transmitting server system 0202 in FIG. 7, the table 05C3 is absent from the table 05C1. The advertisement content displayed on the advertisement displaying device connected to the summary transmitting server system 0202 ZONE10013 may be different from the advertisement content displayed on the advertisement displaying device connected to the summary transmitting server system 0202 of ZONE 10011 (the advertisement content whose advertisement ID is DCT 10-01 is not included in the display schedule for the summary transmitting server system 0202 of is ZONE 10013 in FIG., 7). The display schedules of the advertisement content can be completely identical to each other between the summary transmitting server systems 0202, which have an advertisement displaying device connected thereto. Similarly, the types of summary contents that may be provided to the terminal may also be completely identical to each other between the summary transmitting server systems 0202, which have the access pointer connected thereto.

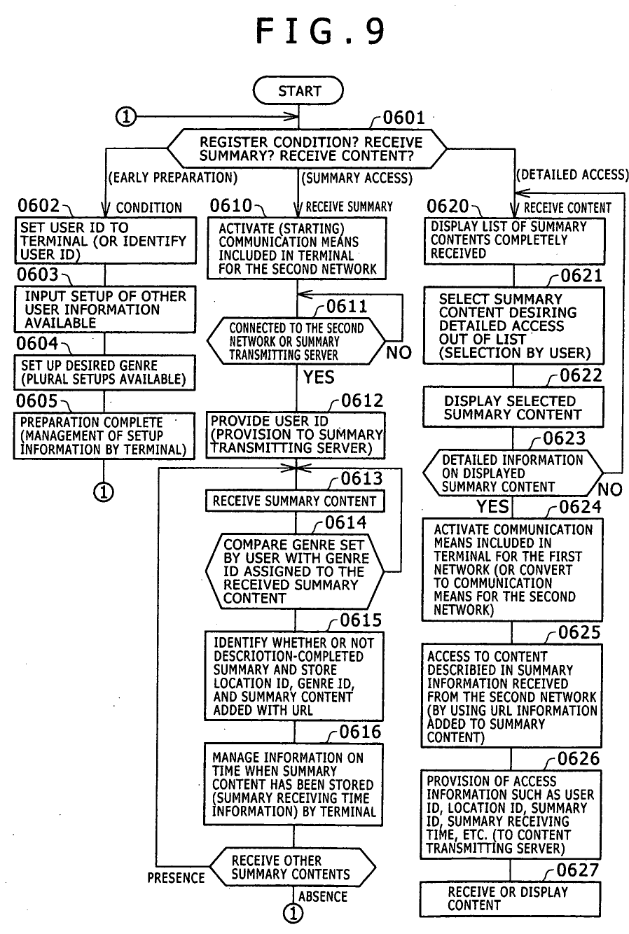

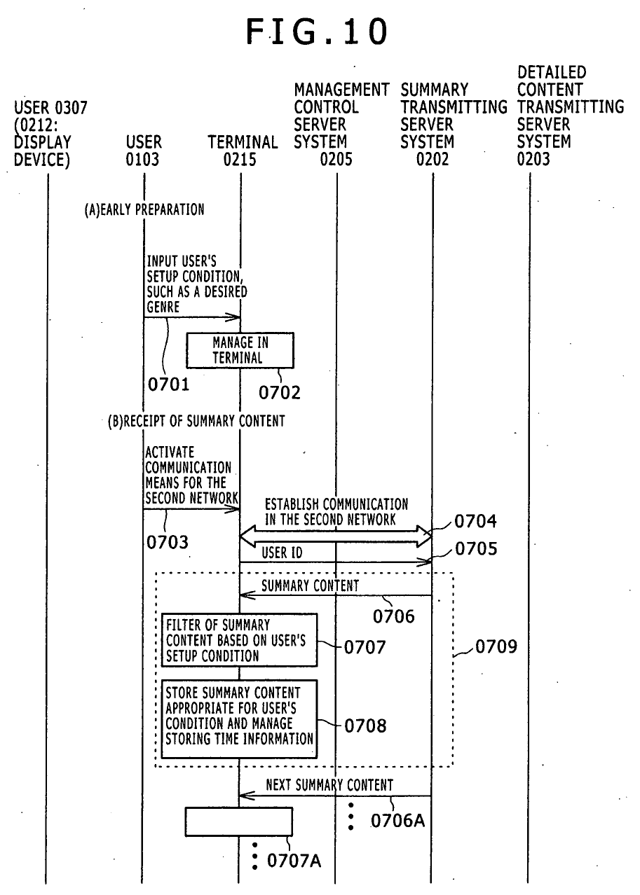

The table indicated by reference numeral 05C3 refers to a list of contents provided by the summary transmitting server system 0202 of ZONE 10011 to the terminal through the access pointer connected to the summary transmitting server system 0202. However, only the summary content which belongs to the genre previously registered by the user carrying the terminal is provided to the user. The terminal performs filtering of the summary content based on genre. In the first embodiment, the genre of the desired content is previously registered to the terminal by the user, which will be described below with reference to FIG. 9 and FIG. 10. By doing so, the terminal performs filtering of the summary content based on information of the genre of the contents registered in the terminal by the user out of the summary contents provided through the access pointer connected to the summary transmitting server system 0202 of ZONE 10011, i.e. the summary contents listed in the table 05C3. Accordingly, the summary content schedule is accompanied with genre information as in the example of the schedule table 05C3. When the terminal is connected to the summary transmitting server system 0202 ZONE 10011 through the access pointer connected to the summary transmitting server system 0202, the summary transmitting server system 0202 of ZONE 10011 provides the terminal with the summary content contained in the table 05C3 (the summary content itself whose content ID is CT 13008 (which corresponds to “abcd. abc” in FIG. 6A), the summary content itself whose content ID is CT 13100 (which corresponds to “bcde. abc” in FIG. 6A), and the summary content itself whose content ID is CT 14001 (which corresponds to “gft0. abc” in FIG. 6A) are sequentially provided to the terminal). At this time, the values of the genre ID and the sub genre ID (for example, JRE 11001 and 0010 in the case of “abcd. abc” in FIGS. 6A to 6C) are stored in each summary content (for example, “abcd. abc” in FIG. 6A). The terminal, which has received the summary content, compares the genre ID value and the sub genre ID value described in the summary content itself with the genre ID value and the sub genre ID value set in the terminal by the user, and stores only the appropriate summary contents. The non-appropriate summary contents are revoked without being stored in the terminal.

Further, it is possible for the service operator or system operator to issue a separate genre table (including genre names and genre ID values) on paper, so that the user may enter genre ID values to the terminal while viewing the genre table, in order to change the genre information registered in the terminal by the user into a genre ID value and a sub genre ID value set by the service operator or system operator (for example, the genre name and genre ID value in the genre table 05A3 in FIG. 5C). However it is not limited thereto, other methods may also be possible. For example, the terminal may be provided with a reader to be capable of reading out the genre name or ID value expressed in a bar code or QR code. As another example, the list of genre names and ID values may be made as a file of any form, and the file may be disclosed in a Web site and separately provided over the Internet, so that the terminal may download the file over the Internet. At this time, the user carrying the terminal may previously download the file onto the terminal.

In the meantime, the two information items, such as the genre ID and the sub genre ID, exemplified in the table 05C4 are not necessary items in the display schedule table for the advertisement content displayed on the advertisement displaying device (i.e. these items may be absent from the display schedule table). That is, it is not necessary, for example, to display the genre ID value, the sub genre ID value, or the genre name corresponding to the ID values on the advertisement displaying device. This merely exemplifies a state where the display schedule for advertisement contents is managed in a form adapted to the schedule for the summary contents.

The two types of schedules are a schedule for summary contents and a schedule for advertisement contents, which are generated (or regenerated) and managed by the management control server system 0205 with respect to each of the summary transmitting server systems 0202 that may be distributed in various locations as in the schedule table 05C2. Also, the summary transmitting server system 0202 may periodically receive the table corresponding to the table 05C2 for the summary transmitting server system 0202 and identify the summary content provided to the terminal through the access pointer that may be connected to the summary transmitting server system 0202 and the advertisement content displayed on the advertisement displaying device that may be connected to the summary transmitting server system 0202.

Hereinafter, generation or regeneration of the two types of schedules by the management control server system 0205 will be described. It is assumed herein that such regeneration of the two types of schedules is performed daily. However, it should be noted that the regeneration of schedules may be performed every hour, every minute, or at any time interval, as well as daily. In FIG. 7, the two types of schedules (a schedule for the summary contents and a display schedule for the advertisement contents) for each of the summary transmitting server systems 0202 that may be distributed in various locations has been summarized as a table indicated by reference numeral 05C1 for the overall summary transmitting server systems 0202. In particular, it is assumed that the table 05C1 refers to a schedule corresponding to one random date, for example March 9, and this table 05C1 is generated at any time on March 8 by the management control server system 0205. It is possible to generate one schedule corresponding to two days, for example, March 9 and March 10 can be generated on March 8. The generation of the schedule at the time point of March 8 (i.e. initial generation time) may be generally performed by the management control server system 0205 based on the provisional condition set by the content provider in FIGS. 6A to 6C. That is, since the summary transmitting server system 0202 whose location ID 10011 is installed in “KINJA” and both the access pointer and the advertisement displaying device are connected to the summary transmitting server system 0202 having location ID 10011, as can be seen in FIGS. 5A to 5C, the summary transmitting server system 0202 having location ID 10011 satisfies the condition for a desired area in FIGS. 6A to 6C, which is limited to “within province”, “eastern part of Japan” (HIGASHINIPPON), and “main cities”, and also satisfies the condition for the effective period of content provision because the schedule shown in FIG. 7 is the one generated in March. Therefore, the three summary contents, each having the content ID CT 13008/13100/14001 and the three advertisement contents, each having the advertisement ID DCT08-02/10-01/99-01 in FIGS. 6A to 6C, are described in the table 05C2 in FIG. 7 (time point of initial generation).

In this state, the management control server system 0205 regenerates the table 05C1 generated on March 8, to March 9. The generation of the table 05C1 is performed so that for example, the table becomes the transmission schedule of the summary content having high popularity or display schedule of the advertisement content having high popularity degree on a corresponding collection data table to be described with reference to FIG. 8, or the display schedule of other advertisement contents of the same genre as the content having high popularity. The summary transmitting server system 0202 that periodically gains access to the management control server system 0205 receives the table 05C2 for the summary transmitting server system 0202 contained in the generated table 05C1 from the management control server system 0205 when it is March 9 and the management control server system 0205 completes the generation, so that the latest schedule corresponding to March 9 is provided from the management control server system 0205 to the summary transmitting server system 0202 (first regeneration).

The collection data table shown in FIG. 8, which is used for regeneration of the schedules, is generated in the management control server system 0205 using the access information. The collection table 05D1 is defined as the one generated by the management control server system 0205 by collecting the access information around the end of the day on March 8. The generated collection table 05D1 based on the collected access information is arranged by the management control server system 0205 for each and every summary transmitting server system 0202 or for each and every summary content that is treated by any summary transmitting server system 0202.

Reference numeral 05D14 denotes the total number of provisions of the summary contents from any summary transmitting server system 0202 to the user (terminal) for one day, on March 8, and reference numeral 05D13 denotes the number of accesses to the detailed content transmitting server system 0203 of the user (terminal) (derived from the summary content) during the day. Further, information on the user that has accessed the detailed content transmitting server system 0203, which is indicated by reference numeral 05D15, is also generated and managed by the management control server system 0205 in addition to the collection and summarization of the access information. The generation of the information may be possible under a membership system. For example, IDs of 98 terminals (users) that accessed the detailed content corresponding to the summary content whose content ID is summary content 13008 are collated into a list by the detailed content transmitting server system 0203, and the list is collected by the management control server system 0205 as the access information, and then a statistical process is performed by using the attribute information associated with the IDs of the access users (by using the attribute information of the access users with the information table corresponding to the user management table 05A1 in FIG. 5A). As a result, it can be easily calculated that 80% of the access users may be in their forties.

Reference numeral 05D11 in FIG. 8 denotes a handling time, during which any summary content is treated by any summary transmitting server system 0202 in a unit time for collecting the access information (it is assumed herein that the collection of the access information is performed on a per-day basis), and reference numeral 05D12 denotes a total time, which is the summed value of the total handling time until the end of the day on March 7 and the time indicated by reference numeral 05D11. That is, the time value calculated by subtracting the time value indicated by reference numeral 05D11 from the time indicated by reference numeral 05D12 means the total handling time of-any summary content in any summary transmitting server system 0202 until March 7.

The management control server system 0205 collects the access information, and then arranges and generates the information items, such as reference numerals 05D11, 05D12, 05D13, and 05D14, and intermittently produces statistical information indicated by reference numeral 05D15 to extract summary content popular in any specified summary transmitting server system 0202 or genre to which the popular summary content belongs. It should be noted that the management control server system 0205 can easily arrange and generate information items other than reference numerals 05D11, 05D12, 05D13, 05D14, and 05D15 by using the access information, and also extract summary content popular in any specified summary transmitting server system 0202 or genre to which the popular summary content belongs. For example, the management control server system 0205 may arrange and generate the information item, such as the total number of derivation, like the total number indicated by reference numeral 05D12, except for the number of derivations to the detailed content transmitting server system during the time interval indicated by reference numeral 05D13 in order to evaluate a degree of popularity. As such, it should be noted that the information items described in the collection table are merely an example. Rather than the names of the information items, it may be critical that the schedule as shown in FIG. 7 is regenerated based on the result obtained by performing a producing process based on the collected access information in the management control server system 0205.

In the access information collection table around the end of the day on March 8, which is indicated by reference numeral 05D1, the number of derivations to the detailed content corresponding to the summary content whose content ID is CT 15001 that is provided from the summary transmitting server system 0202 whose location ID is ZONE is equal to 20/280. Since this is a low value, the first generation of the schedule corresponding to March 9 as described above, the advertisement content whose advertisement ID is DCT20-02 of the same genre whose genre ID is JRE 13100/0001 and to which the CT 15001 belongs may be omitted from the advertisement content display schedule 05C4 in FIG. 7. In addition, there are no descriptions in the schedule for the summary content provided from the summary transmitting server system 0202 whose location ID is ZONE 20111 in FIG. 7. Assuming that the summary content whose content ID is CT 14001 is described in the schedule initially generated (corresponding to March 9), the number of derivations to the detailed content corresponding to the summary content whose content ID is CT 14001 provided by the summary transmitting server system 0202 of ZONE 20111 is equal to 0, as shown in the access information collection table of FIG. 8, similar to the generation of the schedule for the summary transmitting server system 0202 whose location ID is ZONE 10011, and therefore, the summary content whose content ID is CT 14001 is removed from the schedule for the summary content provided from the summary transmitting server system 0202 whose location ID is ZONE 20111.

The schedule from early generation to regeneration (the first regeneration) may be continuously and sequentially performed with respect to the schedule. For example, the second regeneration may be easily performed from the first regeneration, the third regeneration from the second regeneration, the fourth regeneration from the third regeneration, and so on. Even though a case has been described where generation of the schedule is performed on a per-day basis, the present invention is not limited thereto. For example, regeneration may be performed at any time interval such as on a per-hour basis and on a per-minute basis. In this case, also, regeneration may be continuously and sequentially performed with respect to the schedule, and the second regeneration may be easily performed from the first regeneration, the third regeneration from the second regeneration, the fourth regeneration from the third regeneration, and so on. Assuming that regeneration is performed on a per-hour basis, the access information is collected hourly by the management control server system 0205. And, the information item indicated by reference numeral 05D11 corresponds to the time during which any summary content has been hourly treated by the summary transmitting server system 0202. In this case, the information items indicated by the reference numerals 05D13/05D14 correspond to the number of derivations and the number of provisions of the SA, respectively, which are measured every hour. In this case, also, a degree of popularity may be calculated from the information items obtained hourly, and this may be reflected on the table 05C1 shown in FIG. 7 which corresponds to a table of March 9. Similarly, the access information for the next hour may be collected like above, a degree of popularity may be calculated from the information items obtained during the time, and then the result may be reflected, for example, on the table 05C1 shown in FIG. 7 that was generated or regenerated before one hour.

Hereinafter, an operation of the terminal will be described. FIG. 9 is a flowchart illustrating an operation of the terminal according to an exemplary embodiment of the present invention, wherein genre information of a content desired by a user is registered to the terminal and managed (by the terminal), and the terminal receives a content provided from the summary transmitting server system 0202 and the detailed content transmitting server system 0203.

An operation of the terminal may be largely classified into three phases (step 0601): one for registering genre information of a content which the user desires to receive (initial preparation), another for receiving contents from the summary transmitting server system 0202 (summary access), and the other for receiving contents from the detailed content transmitting server system (detailed access). A step for registering (or converting) the genre ID and the sub genre ID defined by the service operator or system operator (for example, a genre table including the genre names and genre IDs described in the genre table 05A3 in FIG. 5C) may be necessary for the operation shown in FIG. 9. As described above, however, various methods for registering the genre table to the terminal may be considered, and as a result, various operations for registering the genre table to the terminal is possible, so that the step for registering the genre ID and the sub genre ID has been omitted from the example of FIG. 9. The registration of the genre table to the terminal may be performed using various methods, as described above, for example, issuing a genre table on paper, entry of user in hand-outs, entry of bar code, and downloading of any types of genre table files to the terminal. As such, the terminal performs such operations as (1) registration of genre table, (2) registration of genre to which a desired content belongs, (3) receiving of summary content, and (4) access to a detailed content through the received (or pre-received) summary content. Therefore, the user can sufficiently activate and manipulate his terminal in order to perform the above operations (1), (2), (3), and (4). It should be noted that operation (2) may be carried out only after operation (1) has been completed in the terminal, and operation (3) may only be performed after operation (2) has been completed, and operation (4) may only be performed after operation (3) has been completed.

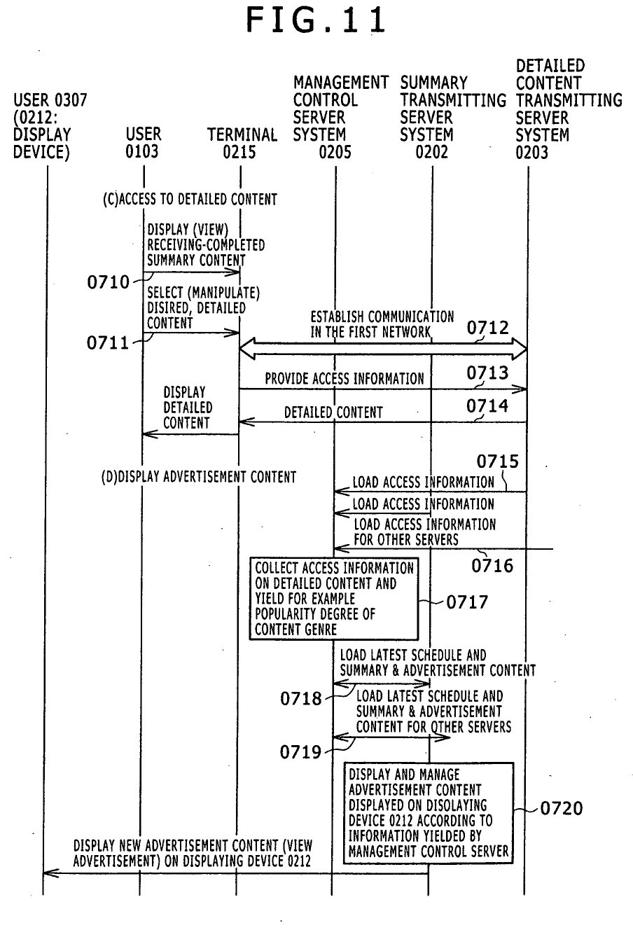

Further, it is assumed that the user of the terminal has a membership in order to receive any service in describing the operations of the terminal. In particular, a user ID, which is assigned to the user under a membership system, is used to receive a content from the summary transmitting server system 0202 and the detailed content transmitting server system 0203. It is also assumed that the user of the terminal has a membership to receive any service in operation sequences to be described below with reference to FIGS. 10 and 11. It should be noted that these operation sequences may be performed under a non-membership system, and this will be simply mentioned below.

In a case where a user activates his terminal to register genre information on a content which he desires to receive, that is, the user selects a condition (initial preparation) for registration initial preparation in FIG. 9, the terminal requests the user to enter his user ID, for example, through a terminal GUI (step 0602). This request of entry of the user ID may be performed to identify the user ID. This step may be easily performed, for example by storing the user ID entered once in the terminal. Under a non-membership system, step 0602 may be omitted from the process.

Before moving from step 0602 to step 0604 where genre information of a content desired by the user is registered, the operation process may further include step 0603 which requests the user to enter his attribute information to the terminal. Step 0603 may be omitted from the process in a case where the user's attribute information is previously stored and managed to/by the management control server system 0205 under a membership system as the user management table 05A1 in FIG. 5A. That is, in the initial preparation of FIG. 9, step 0603 is provided in preparation for a case where the user's attribute table, e.g. such as the user management table 05A1 shown in FIG. 5A, is contained in the management control server system 0205.

The user's attribute information inputted to the terminal in step 0603 is provided from the terminal to the summary transmitting server system 0202 or detailed content transmitting server system 0203 when the terminal gains access to the summary transmitting server system 0202 or detailed content transmitting server system 0203. By doing so, the attribute information on the users that have accessed the summary transmitting server system 0202 and the detailed content transmitting server system 0203 may be collected by the summary transmitting server system 0202 and the detailed content transmitting server system 0203, the collected user's attribute information may be gathered in the management control server system 0205 as a component of the access information, and thus, for example the information item indicated by reference numeral 05D15 in FIG. 8 may be arranged/generated by the management control server system 0205.

Subsequently, from step 0602, or steps 0602 and 0603, in the initial preparation, the user registers the genre information which he desires to receive to the terminal (step 0604). The user may register plural genre information to the terminal. The expression “genre information registered by the user” means selecting of the genre name (and sub genre name) or genre ID (and sub genre ID) described in the genre table 05A3 shown in FIG. 5C, or entering of the genre ID (and sub genre ID).

Among the genre information registered by the user in the initial preparation, the user ID or user's attribute information may be managed in the terminal (step 0605).

If the genre information of the genre desired by the user is registered to the terminal and the user receives the content from the summary transmitting server system 0202, then the user activates the terminal and selects receiving of summary content (step 0601).

If the terminal selects the receiving of the summary content, then the terminal activates its own communication means for the second network (step 0610) to establish communication with the second network. The phrase “establish a communication with the second network” means access to the summary transmitting server system 0202 through an access point that may be connected to the summary transmitting server system 0202. The terminal will fail to establish communication with the second network if no access points are existent around the location where the terminal is positioned (step 0611).

If there is any access points around the location where the terminal is currently positioned, then communication with the summary transmitting server system 0202 is established, in which the terminal provides the user ID to the summary transmitting server system 0202. At this time, the terminal also provides the summary transmitting server system 0202 with the user attribute information together with the user ID (step 0612).

Under a non-membership system, step 0612 may be omitted from the process. Under a membership system, for example, if the information table, such as the table 05A1 shown in FIG. 5A, is previously prepared and managed by the management control server system 0205, step 0603 in FIG. 9 may be omitted from the process (i.e. it is not necessary to manage the user's attribute information in the terminal), and it is not required for the terminal to provide the user's attribute information to the summary transmitting server system 0202. In this case, in step 0612, only the user ID is provided to the summary transmitting server system 0202.

If communication with the summary transmitting server system 0202 is established (step 0611), under a membership system, the user ID continues to provide the user ID to the summary transmitting server system 0202, the terminal provides the summary transmitting server system 0202 with the user's attribute information together with the user ID, and then receives the summary content from the summary transmitting server system 0202 (step 0613).

Here, the summary content received by the terminal is the content itself, for example, a content ID as CT 13008 provided from the summary transmitting server system 0202 of ZONE 10011 in FIG. 7. That is, in this case, the summary content corresponds to the content file “abcd. abc” shown in FIGS. 6A to 6C. Also, if the terminal performs steps 0614, 0615, and 0616 after having received the content file “abcd. abc”, steps 0614, 0615, and 0616 are performed with respect to the content itself (corresponding to “bcde. abc” in FIGS. 6A to 6C) of the same content ID as CT 13100 in FIG. 7. The terminal performs the above routine process on all the summary contents treated by the summary transmitting server system 0202 that has participated in establishing communication in step 0611 of FIG. 9.

In step 0614, the terminal compares the genre information (genre information set corresponding to step 0604) set and registered by the user by his own terminal with the genre ID (and subgenre ID) included in the summary content. Here, in a case where the genre information in the user's terminal matches the genre ID, the process moves to the next step, otherwise, the summary content is revoked and the same comparison is performed with respect to the received other summary content. That is, in FIG. 9, the terminal performs filtering of the summary content based on each genre (step 0614).

With respect to the summary content where the genre information registered in the user's terminal matches the genre ID, the terminal checks whether or not the summary content has been stored in the terminal, and if the summary content has been stored in the terminal, the terminal revokes the summary content, otherwise, the terminal stores the summary content (step 0615).

The summary content stored to the terminal in step 0615 is identified by the user, for example by viewing the summary content in steps 0620 and 0622, to be described below. Also, information, such as a location ID, a (summary) content ID, a genre ID, etc. is contained in the summary content file itself. For example, in the examples of FIGS. 5A to 5C, 6A to 6C, and 7, the content ID as CT 13008, the genre ID (and its sub genre ID) to which the content belongs as JRE 11001•0010, the location ID as ZONE 10011, of the summary transmitting server system 0202 that provides the content to the terminal, and the URL of the detailed content that may be derived from the content, such as xxxx. ne. jp are contained in the summary content whose content ID is CT 13008.

And, in FIGS. 6A to 6C, the location ID as ZONE 10011 is not yet contained in the summary content, for example such as “abcd. abc” at the time point of storing in FIGS. 6A to 6C (at the time point of management in the management control server system 0205 shown in FIGS. 6A to 6C). The summary transmitting server system 0202, which provides the summary content (the summary content not including the location ID, such as abcd. abc in FIGS. 6A to 6C) to the terminal, receives the summary content from the management control server system 0205, has the location ID included in the summary content while managing the summary content, and then provides the terminal with the summary content including the location ID.

Upon storing the summary content in step 0615, the terminal stores the summary content in accordance with time information that indicates when the summary content is stored in the terminal (step 0616). This management corresponds to a relationship between the name of a file and the time when the file is created (or updated), which is usually seen in an OS (Operating System) for a personal computer or file management. The time information, which has been associated with the summary content by the terminal, may be provided to the detailed content transmitting server system 0203 from the terminal when the terminal gains access to the detailed content transmitting server system 0203. Specifically, the time information is provided from the terminal to the detailed content transmitting server system 0203 in step 0626, to be described below. It should be noted that it is not necessary to include the summary content with the time information when the summary content is stored. Specifically, this type of information, such as the receiving time information is critical when the management control server system 0205 determines where and when the summary content in which the user has interest has been received and aggregates the information on whether the user has accessed the detailed content that is derived from the summary content and provided from the detailed content transmitting server system 0203. This type of information may be also used for analyzing the user's trends and inclinations. In changing the displayed advertisement content into another one, the schedule is regenerated so that a popular advertisement content is displayed on the advertisement displaying device (or unpopular advertisement content is changed into a popular one) based on the result of analyzing the user's trends and inclinations. However, it should be noted that the analyzing method itself, such as analyzing the user's trends and inclinations, is not essential in the present invention.

In a case where the user identifies (or views) the summary content after having received the summary content, or in a case where the user identifies (or views) the summary content and is then interested in the summary content to identify (or view) the detailed content corresponding to the SA, the user activates the terminal to gain access to the detailed content (step 0601).

The summary contents received by the terminal may be provided as a list, for example, sorted in the order of receiving date, and then displaying the list (step 0620). Then, the user may select any content which he desires to view from the list (step 0621).

The selection is corresponds to opening the file, such as “abce. abc” received by the terminal from the summary transmitting server system 0202. The summary content is displayed on the terminal by selecting (step 0622), so that the user may determine whether or not to gain access to the detailed content corresponding to the summary content. The determination on whether the user accesses the DC is made, for example, by the user selecting a description portion (displaying portion), such as URL of the DC, displayed on the screen of the terminal. Assuming that the file “abcd. abc” received by the terminal is displayed on the screen, URL “xxxx. ne. jp”, as described in the table 05B1 in FIGS. 6A to 6C, is displayed on the screen. In this case, for example, a phrase such as “to the DC” may also be displayed on the screen on which the file abcd. abc has been displayed so as to lead the user to the DC.

By selecting the displaying portion, such as URL, the terminal subsequently performs steps (steps after step 0624) for accessing the DC corresponding to the summary content that is currently displayed on the screen (in step 0622). In contrast, if the user, who checked (or viewed) the summary content in step 0622, has no interest in the DC, the user may perform a step of returning to the list provided in step 0620 through the screen provided in step 0622. In a case where the user views the summary content and therefore has more interests in the DC, the user may select whether or not to access the DC through the screen of the terminal provided in step 0622 (step 0623).

If the user selects access to the DC corresponding to the summary content displayed on the screen of the terminal (hoping to view the DC), the terminal activates its own communication means for the first network (step 0624). Step 0624 may include a step of changing the communication means for the second network into the communication means for the first network. In a case where the user performs a series of operations, such as activating the communication means for the second network in step 0610, receiving the summary content, storing the summary content in the terminal, viewing the stored summary content (or opening the summary content), and selecting accessing to the DC, the communication means for the second network activated in step 0610 may be changed to the communication means for the first network in step 0624.

If the communication means for the first network is activated (step 0624), then the terminal tries to access the first network using the URL information described in the summary content selected by the user, so that the terminal may gain access to the detailed content transmitting server system 0202 or DC designated by the URL information (step 0625).

If the terminal gains access to the detailed content transmitting server system 0203, the terminal provides the detailed content transmitting server system 0203 with the location ID, the content ID (summary content ID), the genre ID (and, if any, the sub genre ID), the user ID stored in the terminal, and the time information (receiving time information) managed by the terminal upon storing in the summary content, which are received from the summary transmitting server system 0202 (already stored in the terminal) and described in the summary content (step 0626). It should be noted that this step 0626 may be omitted from the process. Also, a more detailed analysis of the user's trends and inclinations may be performed by having the terminal provide the above information (or having the terminal manage or generate the above information). In a case where these types of information are not treated, the information that may be collected by the management control server system 0205 is only the number of accesses to the detailed content transmitting server system 0203 and access residence time. That is, in this case, the detailed content transmitting server system 0203 collates the number of accesses and the residence time at every time interval, and provides the result to the management control server system 0205 at every time interval. The management control server system 0205 receives such information from all the detailed content transmitting server systems 0203 that may be distributed in various locations to extract a popular content or genre to which the popular content belongs based on the number of accesses and the residence time, and reflects the extracted result onto a schedule regenerated by the management control server system 0205. In this case, there may exists a large gap in the analysis of the user's trends and inclinations according to locations or areas where the summary transmitting server systems 0202 are installed, and the change of the advertisement content may take place constantly nationwide. In this exemplary embodiment, various types of information may be treated, but not limited to such types of information described herein (the contribution degree of the exemplary embodiment may increase the analysis of the user's trends and inclinations).

In step 0626, if the terminal provides the information to the detailed content transmitting server system 0203, the terminal displays the DC on its screen (step 0627).

As described herein, the operation process of the terminal may be greatly separated into three phases: registering a genre, which the user desires to receive (initial preparation), receiving the summary content (summary access), and receiving the DC (detailed access) (this operation process may be added with registration of the genre table to the terminal, which is set by the service operator or system operator). In this exemplary embodiment, the service operator or system operator collects information on the fact that the terminal has accessed the summary content and DC (access information of the user who carries the terminal), and based on the collected values (by using the trends of the user carrying the terminal, for example using the collected results such as the popularity) the advertisement content is displayed or changed into another one for unspecified users who are located near the advertisement displaying devices regardless of whether the users carry their terminals.

In other words, in this exemplary embodiment, content is provided for each of the user carrying a terminal and the unspecified user. In particular, the user carrying his terminal is provided with a content of a genre which the user desires to receive through the terminal, and the unspecified users are provided through the advertisement displaying device with a content that is produced (rescheduled) for each summary transmitting server system 0202 by the management control server system 0205 based on the trends (the collected results of the access information) of the user carrying his terminal that have been collected and processed by the management control server system 0205.

FIGS. 10 and 11 show an operation process performed among the terminal, the management control server system 0205, the summary transmitting server system 0202, and the detailed content transmitting server system 0203. In particular, FIG. 10 is a diagram illustrating an example of an operation process concerning initial preparation and receiving of summary content as seen from the terminal, and FIG. 11 is a diagram illustrating an example of an operation process concerning access to the DC and an example of an operation process transmitting a reschedule to the advertisement displaying device, similarly as seen from the terminal. Hereinafter, FIGS. 10 and 11 will be described.

The user carrying his individual terminal registers a user condition, such as a desired genre, to the terminal as the initial preparation (a) (step 0701). The registered information is managed by the terminal (step 0702). Steps 0701 and 0702 correspond to steps 0601 and 0602 to 0605, respectively, in FIG. 9.

After the initial preparation has been complete, the user activates a communication means for the second network (for example, WiFi wireless network) at an outside location, such as a shop, to receive the summary content relating to the desired genre set by the user in the initial preparation. Part (b) of FIG. 10 shows this situation. Further, part (b) of FIG. 10 corresponds to the series of steps 0601 and 0610 to 0616. The terminal may receive the summary content from the summary transmitting server system 0202 connected to the second network, for example, the access point 0106 shown in FIG. 1 installed near the terminal.

For example, if there is no access point 0106 connected to the summary transmitting server system 0202, for example, as shown in FIG. 3, the terminal (or user) fails to activate the communication means for the second network. However, it is assumed herein that communication with the second network has been established (step 0704).

If the terminal recognizes the summary transmitting server system 0202, the terminal provides the user ID information to the summary transmitting server system 0202. At this time, the terminal may also provide the summary transmitting server system 0202 with user's attribute information (step 0705).

The provision of the user ID information (step 0705) corresponds to step 0612 at the process of FIG. 9. That is, under a non-membership system as in step 0612 of FIG. 9, step 0705 may be omitted from the process. Under a membership system, only the user ID may be provided to the summary transmitting server system 0202 without including the user's attribute information.

If the terminal 0202 gains access to the summary transmitting server system 0202 through the second network (step 0705 may be included in or excluded from the process), the whole summary contents (of more than one) owned by the summary transmitting server system 0202 which the terminal has accessed (one or more summary content) is provided from the summary transmitting server system 0202 to the terminal. Step 0706 shows the provision of a first summary content, and step 0706A shows the provision of a second summary content. The summary content transmitted from the summary transmitting server system 0202 is the one that has been periodically scheduled (regenerated) by the management control server system 0205 for the summary transmitting server system 0202 and transmitted to the summary transmitting server system 0202. The summary transmitting server system 0202 changes the transmitted summary content into another one and provides the changed result to the terminal that has accessed the summary transmitting server system 0202 based on the latest schedule received from the management control server system 0205.

As such, genre information (set by the user) is stored in the terminal. In addition, the terminal performs a filtering process on various genres of summary contents received from the summary transmitting server system 0202 through the second network by using the genre information managed by the terminal. Step 0707 of FIG. 7 shows this situation, wherein the genre information of the summary content matches the genre information managed by the terminal, the summary content is stored in the terminal, otherwise, the summary content is revoked. Step 0707 identifies whether the summary content having the matching genre information has been already stored in the terminal or not, and, if so, the summary content is revoked, and then stored in the terminal. That is, step 0707 corresponds to steps 0614 and 0615 in the process shown in FIG. 9.

In addition, upon storing the summary content in the terminal, the terminal manages the summary content in association with time information at the time point of storing the summary content (step 0708). Step 0708 corresponds to step 0616 of FIG. 9 (however, step 0708 may be omitted from the process as described above with reference to step 0616).

The process (step 0709) corresponding to the first summary content, when steps 0706 to 0708 are completed, and the same process is performed for the second summary content and its followings. That is, step 0709 is followed by step 0706 of receiving the subsequent summary content, which corresponds to step 0706 and step 0707A for a process in the terminal (filtering of the summary content received in step 0706A).

The summary content received in the terminal includes the one that had been already received in the terminal rather than the one received in step 0709 of FIG. 10, and this may be identified by the user (step 0710 of FIG. 11). Step 0710 corresponds to steps 0620 to 0623 of FIG. 9.

Here, in a case where the user has more interest in one or more summary content, for example, any summary content, and thus desires to gain access to the DC, the terminal activates the communication means for the first network to access the detailed content transmitting server system designated by the summary content that has been selected by the user (steps 0711 and 0712).

Step 0711 corresponds to selecting “YES” in step 0623 of FIG. 9, and step 0712 corresponds to steps 0624 and 0625 of FIG. 9. That is, the selection in step 0711 is performed by the user, for example, such as selecting a description portion (displaying portion), such as a URL of the DC, contained in the summary content displayed on the screen of the terminal, which corresponds to the DC which the user desires to access. Therefore, the access of the terminal to the DC refers to accessing the first network using the URL information contained in the summary content selected by the user to access the detailed content transmitting server system 0203 designated by the URL information or the detailed content.

If the terminal gains access to the detailed content transmitting server system for the summary content selected by the user (through the first network), the terminal provides the detailed content transmitting server system with the location ID, the content ID (summary content ID), the genre ID (and, if any, the sub genre ID), the user ID stored in the terminal, and the time information (receiving time information) managed by the terminal upon storing the summary content, all of which are described in the summary content. That is, the terminal provides the access information to the detailed content transmitting server system (step 0713).

Step 0713 corresponds to step 0626 in FIG. 9, and this step may be omitted from the process as described above with reference to step 0626. For example, in a case where the terminal does not correlate the summary content itself with the time information upon storing the summary content when managing the time information in step 0708 of FIG. 10, the time information (receiving time information) need not be provided to the detailed content transmitting server system in step 0713.

As such, if the user who desires to access the detailed content selects the terminal (selects access to the detailed content) through the screen on which the summary content has been displayed, the terminal gains access to the detailed content transmitting server system 0203 through the first network by using the URL information described in the selected summary content (in step 0713, the information item provided to the detailed content transmitting server system 0203 by the terminal can be some of the above-mentioned information items, and step 0713 may be omitted from the process) and then receives the DC (step 0714).

Now, the interaction between the user carrying the terminal and each server system is ended. In summary, the terminal experiences the initial preparation process (part (a) of FIG. 10), receives and stores the summary content through the second network (part (b) of FIG. 10), and then accesses the detailed content corresponding to the summary content in a case where the user has interest in the summary content stored in the terminal. In other words, in an aspect, for example, of deriving the DC from the summary content, the actual number of derivations (which refers to, for example, the access information used for description of FIG. 4) is gathered through the detailed content transmitting server system 0203 to the management control server system 0205 or the actual number of derivations relative to the number of transmissions of the summary content is gathered from both the summary transmitting server system 0202 and the detailed content transmitting server system 0203 to the management control server system 0205 (a case will be described below with reference to part (d) of FIG. 11, where the management control server system 0205 collects only the actual number of derivation). That is, the actual number of derivations collected from each of the detailed content transmitting server systems will be described. Accordingly, in a case where the actual number of derivations relative to the number of transmissions of the summary content is collected by the management control server system 0205, the access information, such as the number of transmissions of the summary content, is also collected from each of the summary transmitting server systems to the management control server system 0205 in addition to part (d) of FIG. 11.

The management control server system 0205 collects the trends (the actual number of derivation, or the actual number of derivations relative to the number of transmissions of the summary content) of the user carrying the terminal (for example, the table H shown in FIG. 8), and then generates or regenerates the schedule table (table G) for each and every summary transmitting server system, as described above with respect to FIG. 7, and then transmits the latest schedule table to the summary transmitting server system. By doing so, the summary transmitting server system connected to the advertisement displaying device may change the content (advertisement content) displayed on the advertisement displaying device into another one. That is, the advertisement content to be displayed on the advertisement displaying device is changed into another one for unspecified users (the user indicated by reference numeral 0307 in FIG. 3) that are located near the advertisement displaying device regardless of whether the user carries the terminal or not. Part (d) of FIG. 11 shows this situation.

Steps 0715 and 0716 of FIG. 11 show collecting the actual number of derivations (the access information aggregated in each detailed content transmitting server system0203). As such, the management control server system 0205 periodically collects the information from each of the detailed content transmitting server systems. Also, in a case where the management control server system 0205 periodically collects the access information (for example, the number of transmissions of the summary content) from each of the summary transmitting server systems, step 0715 and step 0716 are the same as each other. Each summary transmitting server system becomes a source of providing the information in steps 0715 and 0716.

The access information thusly collected (the access information collected from each of the detailed content transmitting server systems or both of each of the detailed content transmitting server systems 0203 and each of the summary transmitting server systems) is aggregated as in the table H shown in FIG. 8 by the management control server system 0205, and the result is used for regenerating the schedule table G shown in FIG. 7. The schedule table is generated/regenerated for each and every summary transmitting server system by the management control server system 0205 (step 0717).

The schedule table regenerated by the management control server system 0205 is transmitted to each of the summary transmitting server systems. Steps 0718 and 0719 show this situation. The schedule table transmitted to each summary transmitting server system in steps 0718 and 0719 is the latest one with respect to the summary transmitting server system. The summary transmitting server system (1) changes or updates the summary content to be provided from the access point connected to the summary transmitting server system to the terminal, or (2) changes or updates the advertisement content to be displayed on the advertisement displaying device connected to the summary transmitting server system according to the contents described in the latest schedule table. Step 0720 in FIG. 11 shows this situation. The former step (1) may be omitted from step 0720 if there is no access point connected to the summary transmitting server system. And, the latter step (2) may be omitted from step 0720 if there is no advertisement displaying device connected to the summary transmitting server system.

As such, the summary transmitting server system receives the latest schedule from the management control server system 0205 to change (or update) (1) the summary content and (2) the advertisement content (display content) to be managed in the summary transmitting server system. And, the summary content is provided to the terminal that has accessed the summary transmitting server system and the advertisement content is displayed on the advertisement displaying device connected to the summary transmitting server system. If there is plural advertisement contents, the plural advertisement contents may be sequentially displayed on the advertisement displaying device, or repeatedly displayed on the advertisement displaying device until the summary transmitting server system receives the next schedule from the management control server system 0205.

As such, in the above exemplary embodiment, the user collects the fact that the terminal has received the summary content of an interesting genre or the fact that the terminal has accessed the summary content for the later access to the DC, the management control server system 0205 updates the schedule table (for example, the information table shown in FIG. 7) that is generated/regenerated and managed by the management control server system 0205 based on the collected results and transmits the updated schedule table to each summary transmitting server system. Accordingly, the advertisement content may be displayed on the advertisement displaying device or the advertisement content displayed on the advertisement displaying device is changed into another one for the unspecified users located near the advertisement displaying device regardless of whether they carry their own terminal or not. In particular, the operations and interactions among the terminal, the summary transmitting server system 0202, the detailed content transmitting server system 0203, and the management control server system 0205 have been described in the above exemplary embodiment in a case where the genre information for the user carrying the terminal is registered/managed by the terminal. Hereinafter, a second embodiment will be described.

### Second Embodiment

In the first embodiment, the genre information desired by the user carrying the terminal is registered and managed to/by the terminal, and thus all information contained in the summary content provided from the summary transmitting server system to the terminal is also provided to the terminal.

On the contrary, in the second embodiment, the genre information desired by the user carrying the terminal is previously registered and managed to/by the management control server system. Accordingly, when the summary transmitting server system provides the summary content to the terminal, the summary transmitting server system queries the management control server system for the genre information of the user carrying the terminal, receives the genre information from the management control server system, and then transmits only the summary content having the genre information (or category) designated by the user to the terminal. The descriptions of the other parts are equal to those of the first embodiment.

Hereinafter, the description will focus on the parts of the second embodiment different from the first embodiment. In FIGS. 12, 13, 14, and 15 that are provided for description of the second embodiment, the reference numerals are only assigned to components different from the components of the first embodiment.

FIG. 12 shows an example of a system structure according to the second embodiment of the present invention. The detailed content transmitting server system is equal to that of the first embodiment. The user carrying the terminal previously registers a desired summary content to the management control server system. The management control server system provides a Web server for registering the user. The user gains access to the management control server system through the first network, corresponding to the network 0101B or network 0101C in FIG. 1, (reference numeral 0805 in FIG. 12), and registers predetermined information to the Web server 0801 of the management control server system. The user uses a terminal 0804 for such registration. The terminal 0804 may include, but is not limited to, the terminal 0215 shown in FIG. 2. For instance, the terminal 0804 may include a desktop PC that is used as a fixed terminal at home, and a cellular phone that may have access to the Web. The terminal 0804 may be a terminal that can perform data entry for predetermined information items or data selection in an environment where the terminal may have access to the first network.

The information items registered by the user to the Web server 0801 are generally classified into two groups: one is genre information of summary content desired by the user (including a sub genre), and the other is user's attribute information. The former is the genre information registered and stored to/in the terminal in the first embodiment, and this genre information is provided for registration of a genre of summary content that the user desires to receive. The latter is provided for registration of a membership under a membership system (registration of user information) or for registration of user's attribute information (for example, family structure, gender, age group, and the like). It is assumed that the system is operated under a membership system in the second embodiment.

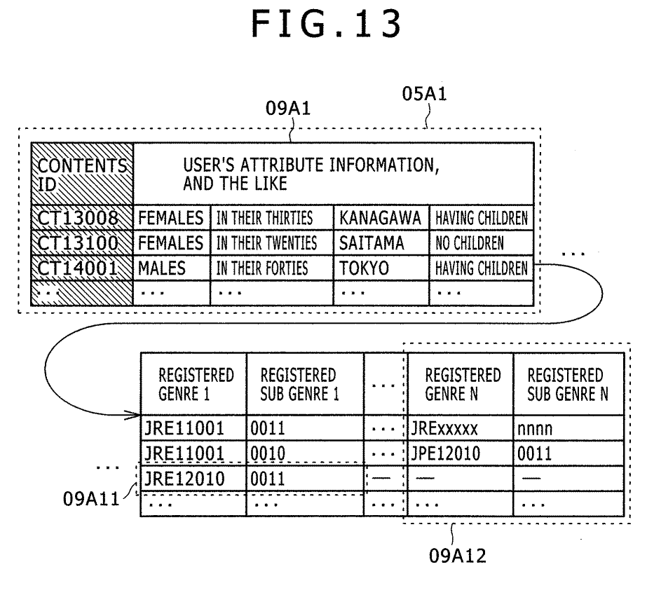

The information registered by the user corresponds to the information contained in user table A (09A1) shown in FIG. 13. This table is an example of the information table managed by the management control server system, and the first row refers to the information registered to the management control server system by a user (of course, it is possible to assign plural membership IDs to a single user). Reference numeral 05A1 in FIG. 13 is an example of the user attribute information items, and this is the same user table A in FIGS. 5A to 5C. In the meantime, the information items other than reference numeral 05A1 in FIG. 13 refer to genre information of summary content which the user desires to receive.

The registration of the genre information to the Web server 0801 shown in FIG. 12 for user registration is performed, for example, when the user enters a predetermined genre name into the Web server 0801 or the user selects a genre from a pull-down menu.

An example of one registered genre information is indicated by reference numeral 09A11 in FIG. 13. FIG. 13 exemplifies a case where the male user having a user ID of CT14001, who has registered the genre information of 09A11, registers only one genre information. Of course, plural genre information, as indicated by reference numeral 09A12, may be registered.

The server 0803 shown in FIG. 12 manages the user table A (09A1) shown in FIG. 13. The server 0803 of the management control server system corresponds to the server 0401 shown in FIG. 4. The information managed in the server except for the user table 05A1 shown in FIG. 5A is the same as that managed by the server 0401 (Reference numeral 05A1 of FIG. 5A is replaced by reference numeral 09A1 of FIG. 13 for the server 0803). The other information tables are identical to one another between the server 0803 and the server 0401. For example, reference numerals 05A2 and 05A3 shown in FIGS. 5A to 5C, reference numerals 05B1, 05B2, and 05B3 shown in FIGS. 6A to 6C, the transmission schedule table shown in FIG. 7, and the collection table shown in FIG. 8 are all stored and managed in the server 0803 shown in FIG. 12.

The genre information registered to the server 0801 shown in FIG. 12 by the user is digitized according to the genre table (for example, reference numeral 05A3 in FIG. 5C), and the digitized information is stored in the server 0803 as shown in FIG. 13. For instance, a male user having an ID such as CT14001 enters or selects genre information such as “formal kids' clothing”, and as a consequence, such information is digitized as a genre ID such as JRE 12010 and as a sub genre ID such as 0011, which is described in the table 09A1 stored in the server 0803 shown in FIG. 13.

A user registration processing unit 0802A shown in FIG. 12 is in charge of communication of information between the server 0801 and the server 0803. The user registration processing unit 0802A performs an application interface, such as reading out the genre table 05A3 shown in FIG. 5C or the user table 09A1 shown in FIG. 13 from the server 0803 and providing them to the server 0801, storing the genre information registered by the user and digitized in the server 0801 in the server 0803, or storing the user's attribute information registered by the user to the server 0801 in the server 0803. The user table 09A1 shown in FIG. 13 is read by the user registration processing unit 0802A and provided to the server 0801 in order for the user to identify the contents registered in the past. As such, some user supporting functions may be provided to the user by the server 0801.

The second embodiment further includes the user registration processing unit 0802A unlike the first embodiment. In this sense, the management control application server 0402 shown in FIG. 4 is different from the application server 0802 in the second embodiment. The other processing units in the application server 0802 are equal to those in the management control application server 0402 except for some processes performed when the summary content is provided to the terminal, which will be described below.

The genre information of the summary content which the user desires to receive is managed by the terminal in the first embodiment, and by the management control server system in the second embodiment, respectively. Accordingly, the first embodiment exhibits a large difference from the second embodiment in a process inside the terminal, a process inside the summary transmitting server system, and a process inside the management control server system in a case where after the terminal has accessed the summary transmitting server system, the summary transmitting server system provides the summary content to the terminal. Accordingly, the terminal 0215, the summary transmitting server system 0202, and the management control server system 0205 shown in FIG. 4 are replaced by the components 0806, 0807, and 0808 shown in FIG. 12, respectively.

As seen in FIG. 12, the terminal 0806 gains access to the summary transmitting server system 0807 through the second network to provide the user ID to the summary transmitting server system 0807. The user ID is received by the summary Web server for terminal of the summary transmitting server system 0807, and then transferred from the Web server to the summary transmitting application server, especially the summary transmitting processing unit. The summary transmitting processing unit queries the management control server system 0808 for the registered genre information associated with the received user ID, together with the process described above with reference to FIG. 4. The registered genre information associated with the user ID is the genre information registered to the management control server system 0808 by the user as described above, in particular, the information managed by the server 0803, for example, the information shown in FIG. 13. The query of the summary transmitting server system 0807 for the registered genre information is performed through the summary Web server of the management control server system 0808, read out from the server 0803 by the summary transmission scheduler processing unit, and provided to the summary transmitting server system 0807 through the Web server for summary. For example, assuming the user of the terminal 0806 shown in FIG. 12 has a user ID CT14001, the summary transmitting server system 0807 sends a query to the system 0808 using the user ID CT14001, and as a result, the information described in reference numerals 09A11 of FIG. 13 is received from the management control server system 0808.

The summary transmitting server system 0807, especially the summary transmitting processing unit, extracts the content from the area provision content management server described in FIG. 4 based on the received genre information, and provides the extracted content to the terminal through the Web server for terminal. The area provision content management server of the summary transmitting server system 0807 stores the summary content as described in FIG. 4 and the summary content is transmitted from the management control server system 0808 to each summary transmitting server system 0807. The transmitting to each summary transmitting server system 0807 means transmitting to each summary transmitting server system 0807 using the schedule generated/regenerated by the management control server system 0808 as described in FIG. 7.

For instance, it is assumed that the summary transmitting server system 0807 shown in FIG. 12 is the summary transmitting server system whose location ID is ZONE 10011 shown in FIG. 7, and the latest schedule is currently the schedule 05C3 (shown in FIG. 7). Also, it is assumed that the schedule of 05C2 (in FIG. 7) described in the schedule 05C3 has been transmitted to the summary transmitting server system whose location ID is ZONE 10011. In this case, assuming that the user of CT14001 has accessed the summary transmitting server system, the information value indicated by reference numeral 09A11 in FIG. 13, such as JRE 12010, 0011 (the genre information value that is received from the management control server system 0808 by request of the summary transmitting server system 0807, that is, the information value where the management control server system receives the user ID from the summary transmitting server system 0807 upon query, extracts the genre information value associated with the user ID from the table shown in FIG. 13 that is managed by the management control server system, and provides the extracted information value to the summary transmitting server system 0807) is not existent in the information table described in the schedule 05C3, and therefore, the summary transmitting processing unit shown in FIG. 12 returns information on the basis of that the summary content associated with the genre registered by the user does not exists, to the terminal through the summary Web server for terminal.

If the summary content of the genre JRE 12010, 0011 existed in the schedule described in 05C3, the summary transmitting server system whose location ID is ZONE 10011 would provide the terminal with the summary content having the content ID described in 05C3 of the same genre (in this case, of course, the content ID has been contained in the information table such as JRE 12010, 0011 in the table 05A3 shown in FIG. 5C that is managed by the management control server system 0808 (especially the server 0803), and the content ID has been also contained in the information table 05B1 shown in FIGS. 6A to 6C, and therefore, the content itself having the same content ID exists in 05B3 shown in FIG. 6).

Therefore, in the second embodiment, the summary transmitting server system 0807 makes a query to the management control server system based on the user ID provided from the terminal 0806, receives the genre information separately registered to the management control server system by the user of the terminal, extracts the summary content managed by the summary transmitting server system 0807 using the genre information, and provides the extracted summary content to the terminal. In addition, the terminal 0806 stores all the summary contents received from the summary transmitting server system. That is, the other operations, processes, and interactions among the terminal, the summary transmitting server system, the management control server system, and the detailed content transmitting server system 0203 are the same as those in the first embodiment.

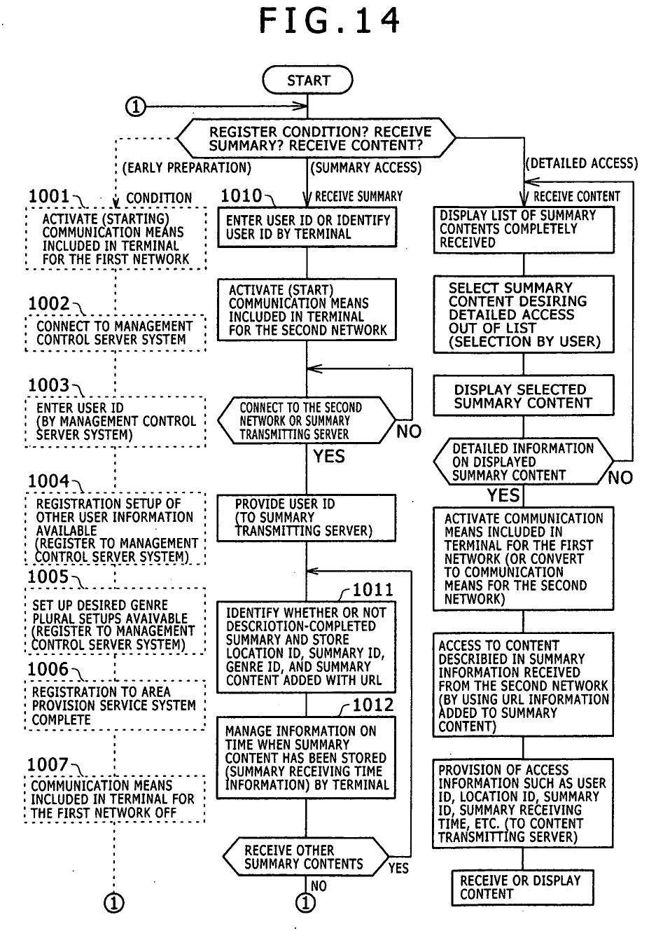

FIG. 14 is a diagram illustrating an example of an operation of the terminal according to the second embodiment of the present invention. In FIG. 14, only the components different from those in the first embodiment have been assigned with reference numerals. As described above with reference to FIG. 12, the second embodiment is different from the first embodiment in terms of registering the genre information of the summary content which the user carrying the terminal desires to receive and filtering the summary content according to the genre associated with receiving of the summary content. However, it is identical to that described in the first embodiment with respect to FIG. 9 when the terminal gains access to the detailed content transmitting server system to receive the DC (the right side of FIG. 14, i.e. “detailed access”).

Firstly, the user registers the genre information of a content which he desires to receive to the management control server system as an initial preparation. Such an initial preparation corresponds to steps 1001 to 1007 in FIG. 14, which in turn correspond to steps 0602 to 0605 in FIG. 4. The registration of the genre information (initial preparation) may be performed with or without the terminal 0806 shown in FIG. 12. This is identical to that described above with reference to reference numeral 0804 of FIG. 12. The registration of the genre information, i.e., initial preparation, is indicated with dotted lines in the operation process performed by the terminal 0806. Steps 1001 to 1007 shown in FIG. 14 may be omitted from this operation process for the terminal shown in FIG. 12. It is assumed in the descriptions of FIG. 14 that the genre information is registered to the management control server system using the terminal 0806 shown in FIG. 12.

In FIG. 14, the operation process of the terminal 0806 shown in FIG. 12, such as a terminal described in the first embodiment with reference to FIG. 9, may be generally classified into three groups: (1) registration of a genre to which a desired summary content belong (initial preparation), (2) reception of the summary content (summary access), and (3) access from the received (or pre-received) summary content to the DC (detailed access). It should be noted that it is assumed that the registration of genre information should be completed in (1) or (2), and any summary content should be capable of being received in the terminal in (2) or (3), as in the first embodiment.

In the second embodiment, in a case where the user activates the terminal to select registration of genre information of summary content which he desires to receive (the initial preparation in FIG. 14), the terminal activates its own communication means for the first network (step 1001) and tries to gain access to the management control server system (step 1002). The management control server system only exists over the network 0101B or 0101C through the first network as shown in FIG. 2. Accordingly, access of the terminal to the management control server system may be easily gained by the information that the management control server system exists over the Internet and the web browser embedded in the terminal is activated to designate URL address of the management control server system. The access location is correspondent to the Web server 0801 shown in FIG. 12.

Upon access to the management control server system, the terminal provides the user ID to management control server system (step 1003). For the provision of the user ID, the user may enter his membership ID to the terminal. Here, in a case where the terminal gains access to the management control server system through a web browser embedded in the terminal, a screen which requests the user to enter his membership ID may be provided from the management control server system to the user through the web browser. The membership ID may be stored in the terminal so that the membership ID once stored may be automatically provided from the terminal to the management control server system when the terminal accesses the management control server system. Other various methods may be implemented for step 1003 in a case where the user performs the membership ID registration to the management control server system for the first time, i.e., the user is not yet assigned with a membership ID. In this case, there may be a need for preparing a window for membership registration on the screen provided from the management control server system to the terminal, so that the user may be directly guided to the window without requiring to enter his membership ID. This function of the management control server system is a general function that is often used on the Internet.

Subsequent to step 1003 shown in FIG. 14, registration of the genre information is usually performed in step 1005 for the content which the user desired to receive. But, before moving to step 1005, the process may further include step 1004 where the management control server system requests the user to enter the user's attribute information. The second embodiment is basically operated under a membership system, and therefore, if the user's attribute information is not managed by the management control server system, step 1004 may be omitted from the process. In this case, as already described in the first embodiment, the information that may be collected in the management control server system only includes, for example, the number of accesses to the detailed content transmitting server system 0203 and the summary transmitting server system and access residence time in the detailed content transmitting server system 0203, and thus this makes it difficult to perform a more specific analysis of the user's trends and inclinations. The management control server system can perform the analysis of user's trends and inclinations by treating many types of this information. Reference numeral 05Al of FIG. 13 refers to an example of the user's attribute information that has been entered in step 1004.

Subsequent to step 1003, or steps 1003 and 1004, the initial preparation registers the genre information of the summary content which the user desires to receive to the management control server system (step 1005). The registration may be performed by user entry and/or selection through a screen provided from the management control server system to the terminal through the web browser. Plural genre information to be registered to the management control server system may be provided.

The genre information set by the user in the initial preparation as well as the user's attribute information are managed by the management control server system 0808 shown in FIG. 12 (step 1006). After completion of the registration, the terminal is disconnected from the management control server system (step 1007).

In the initial preparation, in a case where after registration of the genre information of the summary content desired by the user to the management control server system, for example, the user receives the summary content from the summary transmitting server system through the second network, the second embodiment has the user activate the terminal so that the user may select receiving of the summary content (summary access in FIG. 14) like the first embodiment.

In receiving of the summary content in FIG. 14, the terminal 0806 shown in FIG. 12 activates its own communication means for the second network and gains access to the summary transmitting server system, for example, through the access point 0106 shown in FIG. 2, which is connected to the summary transmitting server system and located near the terminal, like the terminal in the first embodiment. Upon access, the terminal provides the user ID (membership ID) to the summary transmitting server system. In providing the membership ID to the summary transmitting server system, if the terminal stores the user ID in the initial preparation of the second embodiment, the terminal presents the membership ID to the user so that the user may identify the membership ID. If the terminal does not store the membership ID, the terminal requests the user to enter the membership ID (step 1010 of FIG. 14).

Even though it is described in the second embodiment that step 1010 is performed before the activation of the communication means for the second network, the second embodiment is not limited thereto. For example, step 1010 may be performed after access to the summary transmitting server system (before the terminal provides the membership ID to the summary transmitting server system).

After having provided the membership ID to the summary transmitting server system, the terminal receives the summary content from the summary transmitting server system (steps 1011 and 1012). The receiving process of the summary content is different in the first embodiment and the second embodiment, respectively. In the first embodiment, as described above, the summary transmitting server system provides the terminal with various genres of summary contents treated by the summary transmitting server system that the terminal has accessed, and the terminal performs filtering of the summary contents according to the genre information managed in the terminal 128 (only the summary contents appropriate for the genre information values set by the user may be selected by the terminal and stored in the terminal). On the contrary, in the second embodiment, the summary transmitting server system queries the management control server system for the genre information registered by the user having the membership ID to receive the genre information values set by the user from the management control server system, and provides the terminal with only the summary content having the genre information values desired by the user out of various genres of summary contents treated by the summary transmitting server system. Accordingly, in the second embodiment, the terminal stores the whole summary contents received from the summary transmitting server system to the terminal. Steps 1011 and 1012 shown in FIG. 14 are associated with the receiving process of the summary content which distinguishes between the first embodiment and the second embodiment. It should be noted that steps 1011 and 1012 may be equal to steps 0615 and 0616, respectively, shown in FIG. 9. That is, a comparison in receiving of the summary content between the first embodiment and the second embodiment shows that a case where step 0614 of FIG. 9 is included in the process corresponds to the first embodiment and a case which is absent from the process corresponds to the second embodiment. In summary, the presence or absence of t step 0614 differentiates the receiving process of the summary content between the first embodiment and the second embodiment.

If after having received the summary content, the user identifies (or views) the summary content, identifies (or views) any summary content stored in the terminal, or has interest in the summary content, and therefore, tries to access the DC corresponding to the summary content, the series of steps 0620 to 0627 shown in FIG. 9 are performed as in the first embodiment.

As such, the operation process in the second embodiment may be generally classified into three groups: (1) registration of a genre of a desired summary content (initial preparation), (2) reception of the summary content (summary access), and (3) access from the received (or pre-received) summary content to the DC (detailed access). It should be noted that (1) initial preparation is not essential for this process, and the terminal may be replaced by another terminal, such as a desktop PC, as described above with reference to reference numeral 0804 of FIG. 12. Further, in (3) above, the terminal for the second embodiment is the same as the terminal for the first embodiment.

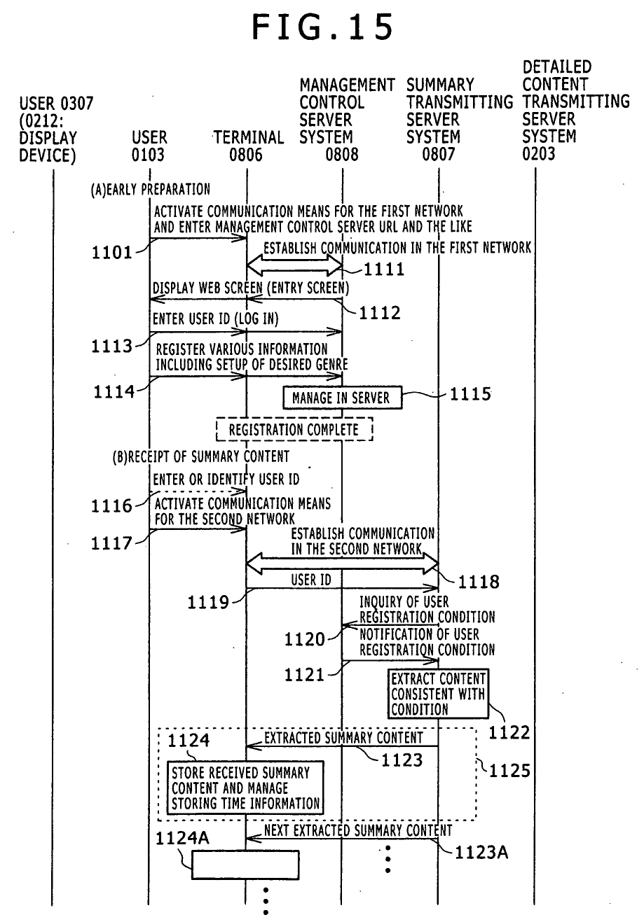

FIG. 15 shows an example of operation process performed among the terminal, the management control server system, and the summary transmitting server system in the second embodiment. In FIG. 15, parts different from those in the first embodiment have been described. That is, the operation process of the second embodiment may be generally classified into four phases: (a) initial preparation, (b) receiving of the summary content, (c) access to the detailed content, and (d) displaying the advertisement content. Here, the phases (c) and (d) are the same as the first embodiment, and therefore, has been omitted from FIG. 15. Also in FIG. 15, the user performs registration of genre information to the management control server system using the terminal 0806 shown in FIG. 12 (the terminal used in the second embodiment). FIG. 15 includes (a) initial preparation. Accordingly, it has been illustrated in part (a) of FIG. 15 that the user communicates with the management control server system using the terminal 0806, but the second embodiment is not limited thereto. For example, the terminal 0806 may be replaced by other terminals, such as desktop PC.

In the second embodiment of FIG. 15, the user carrying the terminal accesses the management control server system over the first network as the initial preparation to perform a membership registration and a registration of genre information of a content the user desires to receive. The user activates the terminal and its own communication means for the first network to gain access to the management control server system (step 1101 of FIG. 15, which corresponds to step 1001 of FIG. 14). At this time, the terminal performs access to the management control server system through, for example, a web browser embedded in the terminal.

If a connection with the management control server system is established (step 1111), a screen for information registration is provided from the management control server system to the terminal. This screen is provided from the Web server 0801 shown in FIG. 12, which may be created in HTML format. The screen is displayed on the terminal for the user through a tool embedded in the terminal (for example, the web browser) (step 1112).

Steps 1111 and 1112 correspond to step 1002 in FIG. 14, and step 1113 corresponds to step 1003 in FIG. 14. Upon access to the management control server system in step 1112, the terminal provides the user ID (membership ID) to management control server system (step 1113). In the provision of the user ID, the terminal may request the user to enter the membership ID or the terminal may store the membership ID so that the membership ID once entered may be automatically provided from the terminal to the management control server system. It may be made possible that before providing the stored membership ID to the management control server system, the terminal presents a screen to the user in order to receive the verification from the user. The registration of the user's membership ID to the management control server system is identical to that described above with reference to FIG. 14.

Subsequent to step 1113, the user registers the genre information of a desired content or user's attribute information to the management control server system (step 1114). Step 1114 corresponds to steps 1004 and 1005 in FIG. 14.

The registered information is managed in the management control server system (step 1115). This management is performed by the management server 0803 shown in FIG. 12 in the same aspect as the user table 09A1 shown in FIG. 13.

After the initial preparation, the user activates the communication means for the second network (for example, WiFi wireless network) at an outside location such as a shop to receive the summary content concerning the desired genre registered in the management control server system during the initial preparation as in the first embodiment. This corresponds to part (b) of FIG. 15, which is titled “receiving of the summary content”. In part (b) of FIG. 15, the terminal receives the summary content from the summary transmitting server system connected to the second network, for example the access point 0106 shown in FIG. 1, through the access point 0106.

The user may receive the summary content which he desires to receive not only in the first embodiment but also in the second embodiment. However, there is a difference in the receiving process between the two exemplary embodiments. In the first embodiment in part (b) of FIG. 10, the summary transmitting server system provides all genres of summary contents to the terminal, extracts the summary contents that meet predetermined conditions from the terminal, and stores the extracted summary contents in the terminal. In the meantime, in the second embodiment as part (b) of FIG. 15, the summary transmitting server system provides the terminal with only the summary contents satisfying predetermined conditions, and the terminal stores such summary contents. If the terminal (or user) is not located, for example near the access pointer 0106 shown in FIG. 1 connected to the summary transmitting server system, the terminal fails to access the summary transmitting server system at the time point of activating the communication means for the second network regardless of whether it is the first embodiment or second embodiment.

If the communication means for the second network is activated (step 1117), so that a connection to the summary transmitting server system is established (step 1118), the terminal provides the membership ID to the summary transmitting server system in the second embodiment.

The provision of the membership ID to the summary transmitting server system (step 1119) corresponds to step 0705 of FIG. 10 in the first embodiment, but both are partially different.

In the second embodiment, the terminal necessarily provides the membership ID to the summary transmitting server system upon access to the summary transmitting server system (step 1119 of FIG. 15). This membership ID is used for the summary transmitting server system to query the management control server system (that is, the membership ID is used to receive the user's genre information registered to the management control server system, and the received genre information is used for filtering of the summary contents in step 1122 to be described below). Also, the membership ID is used for aggregating an information item of the access information by the management control server system from the summary transmitting server system in a case where the user's attribute information is managed by the management control server system. In a case where the user's attribute information is not managed in the second embodiment, the latter is not necessary. In this case, the terminal provides the membership ID to the management control server system only for the former use.

In the meantime, the first embodiment may be modified depending on whether the membership is required or not. That is, step 0705 may be omitted from part (b) of FIG. 10 when a non-membership system is used. In a case where the user's attribute information is managed by the management control server system under a membership system (in a case where the user table such as 05A1 shown in FIG. 5A is managed in the management server 0401 of FIG. 4), the provision of the membership ID to the summary transmitting server system is inevitable even in the first embodiment. In this sense, the step 0705 shown in FIG. 10 is included in the first embodiment.

Before the terminal provides the membership ID to the summary transmitting server system in step 1119, the terminal requests the user to enter the membership ID in step 1116 of FIG. 15. Step 1116 corresponds to step 1010 of FIG. 14. As described above with reference to FIG. 14, if the terminal has a function of storing the membership ID, the terminal may present the membership ID stored in the terminal to the user so that the user may verify it. Even though step 1116 precedes step 1117 for activating the communication means in FIG. 15, the present invention is not limited thereto. For example, step 1116 may be simultaneously performed with step 1119 or before step 1119.

As such, if the terminal accesses the summary transmitting server system and provides the membership ID to the summary transmitting server system, the summary transmitting server system queries the management control server system using the received membership ID to receive the genre information values registered to the management control server system by the user having the membership ID (query step 1120, genre information receiving step 1121).

The genre information values of which the summary transmitting server system receives from the management control server system may include, for example, the information indicated by reference numeral 09A11 in FIG. 13. The information 09A11 corresponds to single genre information registered by the user. Plural information 09A11 may be provided.

The genre information received by the summary transmitting server system in step 1121 of FIG. 15 is used for filtering of the summary content in step 1122. The filtering of the summary content in the second embodiment refers to extracting the summary contents matching the received genre information among all of the genres of the summary contents collected by the summary transmitting server system. That is, in step 1122 of FIG. 15, the summary transmitting server system extracts the summary content having the desired genre information from the summary contents managed by the area provision content management server shown in FIG. 12. Accordingly, in the second embodiment, the terminal stores the whole summary contents received from the summary transmitting server system after step 1122 in the terminal. Step 1125 of FIG. 15 shows a routine step for a first summary content received from the summary transmitting server system.

All of the genres of the summary contents treated by the summary transmitting server system are as follows. If the summary transmitting server system is the summary transmitting server system whose location ID is ZONE 10011 described in the table 05A2 shown in FIG. 5B, All of the genres of the summary contents treated by the summary transmitting server system mean the all of the genres and summary contents described in the table indicated by reference numeral 05C3 that is contained in the schedule table shown in FIG. 7. In FIG. 7, the summary transmitting server system whose location ID is ZONE 10013 has no genres of the summary contents therein (it is exemplified in FIG. 7 that there are no summary contents treated by the summary transmitting server system). It should be noted that FIG. 7 shows only the state of the information table generated (or regenerated) and managed by the management control server system, but not by the summary transmitting server system. However, the information table such as 05C2 shown in FIG. 7 is transmitted from the management control server system to each of the summary transmitting server systems, and the all of the summary contents managed in the summary transmitting server system whose location ID is ZONE 10011 corresponds to 05C3 shown in FIG. 7. This is also true for the advertisement content. The overall advertisement contents managed in the summary transmitting server system whose location ID is ZONE 10011 corresponds to 05C4 shown in FIG. 7. In other words, the contents (both the summary contents and the advertisement contents) managed by the summary transmitting server system whose location ID is ZONE 10011 all correspond to 05C2 of FIG. 7.

In FIG. 15, after step 1122, filtering of the summary content, the summary transmitting server system provides the first summary content extracted in step 1122 to the terminal (step 1123). At this time, in a case where the corresponding summary content does not exist in the filtering process of step 1122, the summary transmitting server system returns information on the intent that there is no summary content concerning the genre registered by the user to the terminal.

The summary content provided from the summary transmitting server system in step 1123 is stored in the terminal. Upon storing the summary content, the terminal performs step 0708 shown in FIG. 10 like the terminal in the first embodiment (step 1124 of FIG. 15). Step 1124 corresponds to steps 1011 and 1012 of FIG.14. Step 1124 may be omitted from the process like step 0708 of FIG. 10 in the first embodiment. That is, the time information with which the terminal correlates the summary content in step 1124 refers to a kind of information provided from the terminal to the detailed content transmitting server system when the terminal gains access to the detailed content transmitting server system 0203, and this time information is not required unless the detailed content transmitting server system collects the time information.

Also, in step 1125 for one summary content, including step 1123 of receiving the summary content and step 1124 of storing the received summary content, the terminal identifies whether or not the received summary content (in step 1123) has been completely stored in the terminal, and if it is determined that the summary content has been stored in the terminal, the terminal revokes the received summary content, otherwise, repeats steps 1123 and 1124.

In the second embodiment, the summary transmitting server system provides the terminal with the summary content extracted in step 1122 of FIG. 15 (this summary content is the one satisfying the genre which the user desires to receive, and is usually extracted in plurality. Also, if there are no summary contents satisfying the genre, it is notified to the terminal in step 1123). In FIG. 15, the provision of a first summary content corresponds to step 1123, and the provision of a second summary content corresponds to step 1123A. That is, in FIG. 15, after the routine process (step 1125) for a single summary content, such as steps 1123 and 1124, has been completed, the same process also continues for a second summary content and its following. Step 1123 and 1124 are followed by step 1123A of receiving the next summary content and step 1124A that is processed inside the terminal, which corresponds to steps 1123 and 1124, respectively. For example, step 1124A may include a process such as identifying whether the summary content received in step 1123A has been stored in the terminal or not, so that if the summary content is not stored in the terminal, the terminal stores the summary content, and if the summary content has been stored in the terminal, the terminal revokes the summary content or manages the time information upon storage.

When after having received the summary content, the user identifies (or views) the summary content, identifies (or views) any summary content stored in the terminal, or has interest in the summary content, and therefore, tries to access the DC corresponding to the summary content in FIG. 6C, the series of steps 0620 to 0627 shown in FIG. 9 are performed as in the first embodiment.

In the second embodiment, also the management control server system collects the trends (the number of access) of the user carrying the terminal that has accessed each of the summary transmitting server system and the detailed content transmitting server system, updates the schedule table (for example, the information table shown in FIG. 7) generated/regenerated and managed by the management control server system based on the collected results, and transmits the updated schedule table to each of the summary transmitting server systems in order to be capable of displaying the advertisement content or changing the displayed advertisement content into another one for the unspecified users located near the advertisement displaying device regardless of whether or not the user carries his own terminal. This series of processes are the same as those in the first embodiment.

What is claimed is:

1. An electronic advertisement system comprising:
an advertisement displaying device that displays an advertisement based on a schedule;
at least one local area network that transmits a summary of a content to a terminal;
a wide area network that has a second communication area including a first communication area contained in at least one local area network, the wide area network gaining access to a detail of the content corresponding to receiving of the summary by the terminal; and
a center device connected to the advertisement displaying device, the local area network, and the wide area network, wherein the center device stores the details of the content, monitors the access to the stored detail of the content, and changes the schedule of an advertisement displayed on the advertisement displaying device located near the first communication area based on the monitored result.

2. The electronic advertisement system of claim 1, further comprising:
a summary transmitting server system connected to the center device, the summary transmitting server system being installed to correspond to the local area network, wherein the summary transmitting server system stores the summary of the content and transmits the stored summary of the content to the terminal through the local area network.

3. The electronic advertisement system of claim 2,
wherein the terminal generates summary access information from transmitting information transmitted from the summary transmitting server system, transmits the summary access information to the center device when gaining access to a detailed content corresponding to the summary, and the center device changes the schedule of the advertisement displayed on the advertisement displaying device located near the first communication area based on the monitored result of the access to the detail and monitored result of the summary access information.

4. The electronic advertisement system of claim 2,
wherein the center device stores genre information concerning the content registered to correspond to a user ID relating to the terminal, and the summary transmitting server system receives the genre information according to the user ID of the terminal connected through the local area network from the center device and transmits a summary of a content corresponding to the genre information to the terminal through the local area network.

5. The electronic advertisement system of claim 4,
wherein the terminal generates summary access information from transmission information transmitted from the summary transmitting server system, transmits the summary access information to the center device when gaining access to a detailed content corresponding to the summary, and the center device changes the schedule of the advertisement displayed on the advertisement displaying device located near the first communication area based on the monitored result of the access to the detail and monitored result of the summary access information.
